(19) United States
(12) Patent Application Publication
(10) Pub. No.: US 2026/0181157 A1
(43) Pub. Date: Jun. 25, 2026

(54) RESIDUE FRAME PREDICTION IN VIDEO COMPRESSION FOR LOW-LATENCY AND ULTRA-LOW-LATENCY STREAMING

(71) Applicant: Adeia Guides Inc., San Jose, CA (US)

(72) Inventor: Tao Chen, Palo Alto, CA (US)

(21) Appl. No.: 18/999,938

(22) Filed: Dec. 23, 2024

(51) Int. Cl. H04N 19/14; H04N 19/172

(52) U.S. Cl. CPC H04N 19/14; H04N 19/172

(57) ABSTRACT

Methods and systems are provided for enhancing video compression through advanced encoding processes, motion prediction, and block-based prediction frames. The methods and systems may include generating frame-level and block-based predicted frames, estimating residual complexity, and configuring encoders accordingly. Motion autoencoders, layered distribution adaptors, and neural networks are also provided to generate and refine motion cues, optical flow, and occlusion maps. The methods and systems also include motion prediction and compensation using reconstructed frames and block matching algorithms, and dynamically adjusting encoding parameters based on real-time feedback and scene changes. Additionally, the methods and systems include accessing and aggregating block-based prediction frames to improve target frame predictions, minimizing prediction errors, and maintaining consistency in residues. The methods and systems improve encoding efficiency, reduce latency, and adaptively control bitrates. Historical data and feedback mechanisms further improve prediction modules and encoder settings.

### FIELD OF THE DISCLOSURE

The present disclosure relates to content delivery, including low-latency and ultra-low-latency content (e.g., video) delivery, video services, gaming, processing, and rendering.

### SUMMARY

In order to achieve low-latency content delivery, various approaches have been attempted for rate control and video compression including SimVP, which is a simple convolutional neural network (CNN)-based model for video prediction, and ExtDM, which predicts video frames by extrapolating motion cues, balances efficiency and accuracy, and utilizes a layered distribution adaptor and motion autoencoder. However, these approaches have limitations. For instance, both models are not fully developed, i.e., SimVP is described as a baseline and inspiration for future research, and ExtDM is described as having potential uses.

To help address the limitations and problems of these and other approaches, methods are provided directed to various techniques for video compression, emphasizing encoding processes, motion prediction, and block-based prediction frames. The methods comprise implementing an encoding process for encoding sequences of frames, generating frame-level and block-based predicted frames, and estimating residual complexity to configure encoders. The methods provide encoding by adjusting parameters based on predicted complexity and, in some implementations, trained models or neural networks are provided for prediction.

In some embodiments, a method comprises encoding a sequence of uncompressed frames using one or more encoders. The method generates a frame-level predicted frame for an upcoming uncompressed frame based on a previously encoded frame. A block-based predicted (BBP) frame is created by comparing information from previously encoded frames. The residual complexity of the uncompressed frame is estimated by comparing the frame-level predicted frame and the BBP frame. The encoders are configured based on this estimated residual complexity before the uncompressed frame is available for encoding. The method includes generating an encoded frame for the uncompressed frame using the configured encoders. The method also comprises comparing motion information and previous frames, adjusting quantization parameters (QPs), determining and dynamically adjusting the number of encoders, and using trained models or neural networks for generating BBP frames through spatial and temporal prediction.

In some embodiments, a method comprises encoding a sequence of uncompressed frames using one or more encoders. Motion cues are generated from the uncompressed frames using a motion autoencoder, and future motion cues are extrapolated using a layered distribution adaptor. The residual complexity of an upcoming uncompressed frame is estimated based on these future motion cues. An encoded frame is then generated for the uncompressed frame based on the estimated residual complexity to reduce video compression latency. The method also includes generating optical flow and occlusion maps, using a Gaussian distribution model for extrapolation, dynamically adjusting the number of encoders, using frame-synced parallel encoders, refining motion cues with a spatiotemporal-window U-Net, making encoding decisions based on residual complexity, adjusting QPs, performing a bijection transformation, and adjusting encoding parameters based on real-time feedback from a client device.

In some embodiments, a method comprises performing motion prediction and motion compensation on a block basis, relying on encoded and decoded reference pictures. Motion prediction generates a target frame (P(t)) based on a reconstructed frame (D(n)), and motion estimation is performed using an uncompressed frame (F(t)) and the target frame (P(t)). The motion prediction can be generated from, e.g., one reconstructed frame (D(n)) or using multiple reconstructed frames selected based on their temporal proximity to the target frame. Motion compensation is applied to blocks of the target frame using motion vectors derived from the reconstructed frame. These vectors are calculated using a block matching algorithm. The method also includes transmitting encoded motion vectors and residuals to a decoder, where residuals represent differences between predicted and encoded blocks of the target frame. Additionally, the reconstructed frame is generated by decoding a previously encoded frame, and motion prediction for the target frame can be based on aggregated predictions from multiple reconstructed frames.

In some embodiments, a method comprises accessing block-based prediction frames (B(n)) for video compression, where (n=t−d) with (d=1, . . . , N). These frames are aggregated to form a block-based prediction frame (Pb(t)), which is then used along with an uncompressed frame (F(t)) to generate an improved prediction of a target frame (P(t)). The block-based prediction frames are accessed from the encoding of past frames and can be generated without additional processing or latency. They are based on decoded reference frames from previously encoded frames. The aggregation process combines motion vectors and residuals from multiple blocks, calculated using a block matching algorithm. The method also includes reducing the estimation of residual complexity based on the block-based prediction frame, selecting prediction frames based on their temporal proximity to the target frame, and predicting residual complexity by minimizing the difference between the block-based prediction frame and the encoded target frame.

In some embodiments, a method comprises determining differences between reconstructed frames (D(n)) and block-based prediction frames (B(n)), where (n=t−d) with (d=1, . . . , N), representing encoded residues of previous frames. These block-based prediction frames are aggregated to form a block-based prediction frame (Pb(t)). A difference between a prediction frame (P(t)) and the block-based prediction frame (Pb(t)) is determined as a predicted residue of a frame (F(t)). An estimation module then generates settings for one or more encoders to encode the frame (F(t)) based on the prediction frame and the block-based prediction frame. The method includes generating encoder settings without dependency on the arrival of the frame, determining the number of encoders based on the predicted residue, and setting QPs and motion vector information. The method also comprises block-based motion estimation and compensation, minimizing prediction error, dynamically adjusting encoding parameters, performing real-time block-based motion estimation and compensation to reduce latency, and adaptively controlling the bitrate of the encoded video bitstream based on the complexity of the predicted residue.

In some embodiments, a method comprises accessing information from various prediction frames, including prediction frames (P(t)), past frames (P(n)), predicted block-based predictions of previous frames (Pb(n)), and encoded block-based predictions of past frames (B(n)). An estimation module uses this information to make encoding decisions for one or more encoders. The method also includes detecting scene changes in the current frame (F(t)) and adjusting encoder settings based on these changes. The method comprises constructing inputs and outputs for training neural network models for video compression, generating predicted block-based predictions using motion estimation techniques, and refining the prediction module based on feedback. Additionally, the method includes dynamically adjusting encoder settings, maintaining consistency in residues through motion estimation, and triggering a refresh of settings when scene changes are detected.

Related devices, systems, non-transitory computer-readable media, and the like are provided for low-latency and ultra-low-latency content delivery, processing, and/or rendering.

The present invention is not limited to the combination of the elements as listed herein and may be assembled in any combination of the elements as described herein. These and other capabilities of the disclosed subject matter will be more fully understood after a review of the following figures, detailed description, and claims.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration these drawings are not necessarily made to scale.

The embodiments herein may be better understood by referring to the following description in conjunction with the accompanying drawings in which like reference numerals indicate identical or functionally similar elements, of which:

FIG. 1 depicts a system including a source, an estimator, one or more encoders, and a client, in accordance with some embodiments of the disclosure;

FIG. 2 depicts predicted pictures in a cloud gaming environment with a GOP structure (including intra (I), predicted (P), and bidirectional (B) coded pictures) with all P-pictures following the I-picture, in accordance with some embodiments of the disclosure;

FIG. 3 depicts I-pictures in a cloud gaming environment with the GOP structure where the GOP size is about two seconds, in accordance with some embodiments of the disclosure;

FIG. 4 depicts an example of an instant scene change resulting in a very large predicted coded picture (P-picture) and a corresponding chart of arrival time versus frame size, in accordance with some embodiments of the disclosure;

FIG. 5 depicts an architecture of a video encoder for the system of any of FIGS. 7-9 and 15, in accordance with some embodiments of the disclosure;

FIG. 6 depicts an architecture of a rate controller within the video encoder of FIG. 5, in accordance with some embodiments of the disclosure;

FIG. 7 depicts a prediction module and an estimation module for frame extrapolation and complexity estimation, in accordance with some embodiments of the disclosure;

FIG. 8 depicts a video encoder for video encoding, reconstruction, and decoding, in accordance with some embodiments of the disclosure;

FIG. 9A depicts a reference frame for block-based prediction, in accordance with some embodiments of the disclosure;

FIG. 9B depicts a current frame for block-based prediction, in accordance with some embodiments of the disclosure;

FIG. 9C depicts a block-based prediction frame for block-based prediction, in accordance with some embodiments of the disclosure;

FIG. 9D depicts a comparison of frame differences (or residues) for block-based prediction, wherein the frame difference is from a shift of one pixel, in accordance with some embodiments of the disclosure;

FIG. 9E depicts a comparison of frame differences (or residues) for block-based prediction, wherein the frame difference is after block-based compensation, in accordance with some embodiments of the disclosure;

FIG. 10 depicts a prediction module and an estimation module for frame extrapolation based on decoded pictures for frame predicting in video compression, in accordance with some embodiments of the disclosure;

FIG. 11 depicts a prediction module and an estimation module for estimation of aggregated block-based prediction pictures for an upcoming frame in video compression, in accordance with some embodiments of the disclosure;

FIG. 12 depicts a prediction module and an estimation module for a difference between a frame-based prediction and an aggregated block-based prediction picture, in accordance with some embodiments of the disclosure;

FIG. 13 depicts an estimation module for a difference between a frame-based prediction and an aggregated block-based prediction picture including a prediction of past frames, a predicted block-based prediction of past frames, and a block-based prediction of past frames, in accordance with some embodiments of the disclosure;

FIG. 14 is a flowchart of a method for frame-level and block-based prediction for video compression, in accordance with some embodiments of the disclosure;

FIG. 15 is a flowchart of a method for a motion autoencoder and layered distribution for latency reduction, in accordance with some embodiments of the disclosure;

FIG. 16 is a flowchart of a method for block-based motion prediction and compensation, in accordance with some embodiments of the disclosure;

FIG. 17 is a flowchart of a method aggregating block-based predictions for improved frame prediction, in accordance with some embodiments of the disclosure;

FIG. 18 is a flowchart of a method for encoding with predicted residue and dynamic adjustment, in accordance with some embodiments of the disclosure;

FIG. 19 is a flowchart of a method for feedback-enhanced prediction and scene change detection, in accordance with some embodiments of the disclosure;

FIG. 20 depicts an artificial intelligence (AI) system, in accordance with some embodiments of the disclosure; and

FIG. 21 depicts a system including a server, a communication network, and a computing device for performing the methods and processes, in accordance with some embodiments of the disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting exemplary embodiments and that the scope of the present invention is defined solely by the claims.

### DETAILED DESCRIPTION

Residual complexity of a frame is estimated before receiving an actual frame, which allows update of one or more encoder settings. For example, methods and systems are provided for residue frame prediction in video compression for low-latency streaming. In video compression for low-latency streaming, it is highly desirable to have an accurate estimate of video complexity prior to an actual encoding. For example, the accurate estimate prior to encoding improves compression performance, e.g., in single pass encoding, and ultimately reduces overall latency. Also, for example, a block-based motion estimation process is provided for frame prediction in video compression. Further, for example, improved of residue complexity estimation are provided. In addition, for example, the improvements in residue complexity estimation result in improved encoding results. Moreover, for example, either alone or in combination with one or more features of the methods and systems disclosed herein, frame-level and/or block-based video representations are provided for predicting the residue complexity of an upcoming frame. In some embodiments, estimated residue comprises a block-based representation, which closely simulates video compression. Furthermore, for example, prediction and estimation lead to early decisions independent of an actual frame. As such, for example, by the time a frame arrives, encoding is kicked off immediately (e.g., simultaneously or very nearly simultaneously, less than about a millisecond; that is, e.g., the encoder does not perform processing or analysis on the frame prior to encoding the frame). Also, as such, for example, the prediction and estimation leading to the early decisions independent of the actual frame permit immediate encoding and further reduce latency.

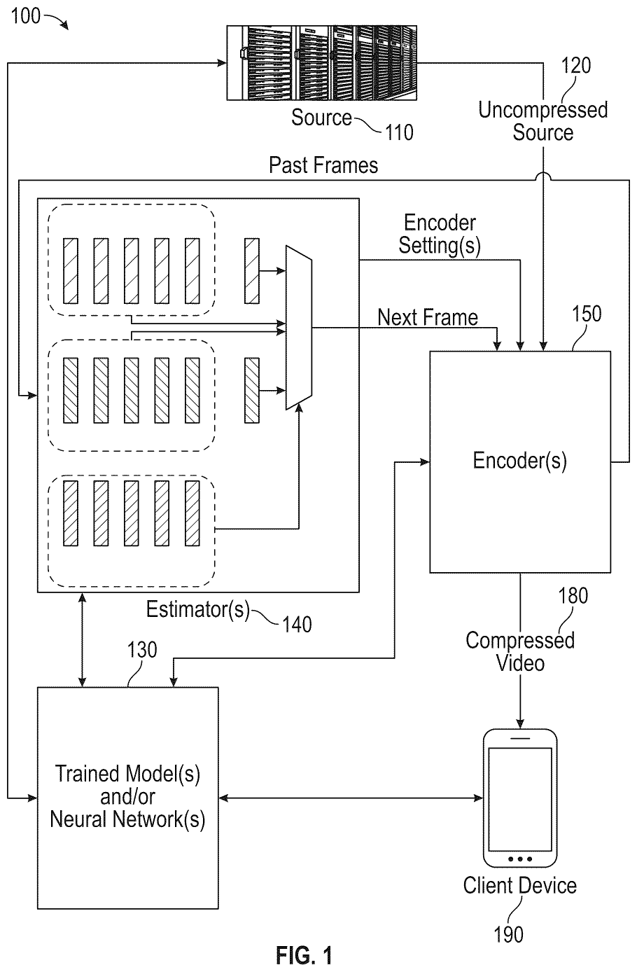

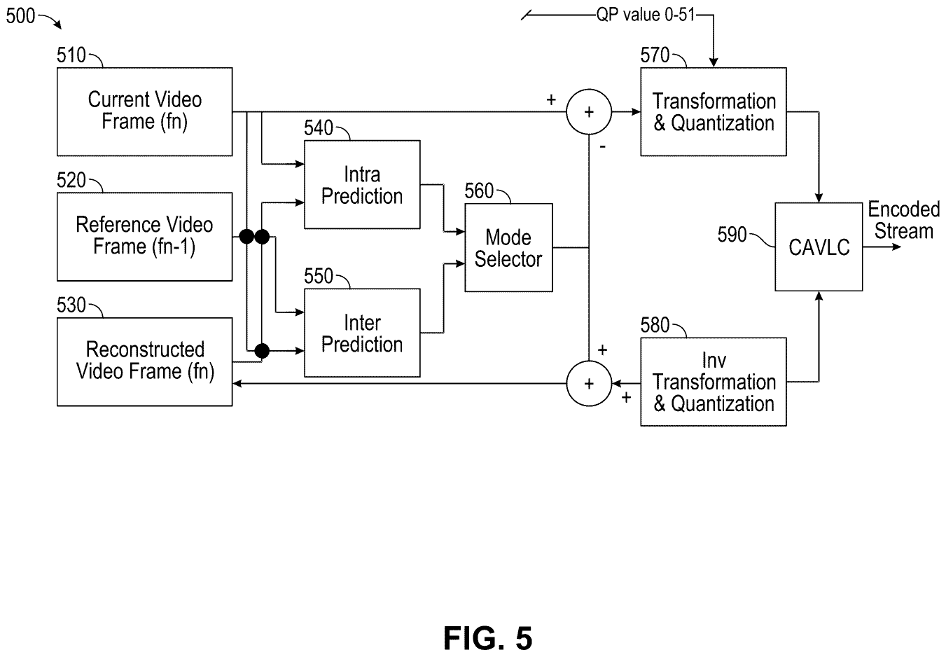

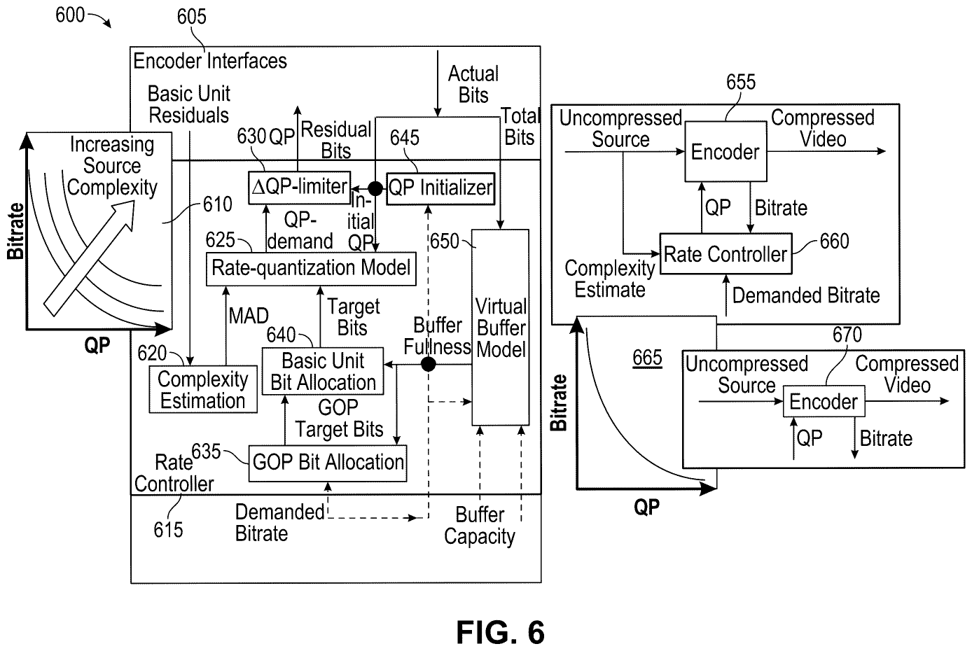

For example, FIG. 1 illustrates a system 100, which includes several components: a source 110, an estimator 140, an encoder 150 having one or more encoder instances, and a client device 190. The system 100 is configured to efficiently control and transmit (e.g., video) data. The source 110, e.g., a game engine or another data-generating entity, is configured to generate an initial data stream, e.g., data in an uncompressed format, referred to as uncompressed source 120. In some embodiments, at least one of the source 110, the estimator 140, the encoder system 150 (or components thereof), the client device 190, combinations of the same, or the like, exchange data with one or more trained models and/or neural networks 130, as detailed herein. For example, the estimator 140 is configured to transmit one or more encoder settings to one or more encoders of the encoder system 150. The estimator 140 may be configured in a manner consistent with at least one of estimation module 750, estimation module 1050, estimation module 1150, estimation module 1250, estimation module 1350, combinations of the same, or the like (detailed herein). The estimator 140 may be configured with a prediction module including the functionality of at least one of prediction module 710, prediction module 1010, prediction module 1110, prediction module 1210, combinations of the same, or the like (detailed herein). The encoder 150 is configured to receive and process the uncompressed source 120 through the encoder 150, depending on requirements of the system 100. Exemplary details in various embodiments of the encoder 150 and/or the first encoder instance 160 to the n-th encoder instance 170 are provided in Phillips et al. and Mathai et al., which are described in greater detail herein. One function of the encoder instances is to compress the (e.g., video) data, making the data more manageable for transmission. The client device 190 (e.g., smartphone (as shown), display device, dongle, set-top box, media streaming device, PC, game console or the like), receives compressed video (e.g., video bitstream) 180. In some embodiments, one or more features of the system 100 includes one or more features of the methods and systems described herein with reference to FIGS. 5-6.

Video encoding for ultra-low-latency video is extremely challenging when attempting to keep the video within a capped bitrate. In video encoding, there are I-pictures, P-pictures and B-pictures. Typically, I-pictures are very large in comparison to P-pictures and B-pictures, depending on the complexity of the video from frame to frame. As noted above, there are cases where a P-picture is larger than an I-picture. In extreme high motion video, both P-pictures and B-pictures can be very large, especially in the case of an instant scene change. A scene change example is where the picture to encode is, for example, completely or significantly different than the previous encoded picture.

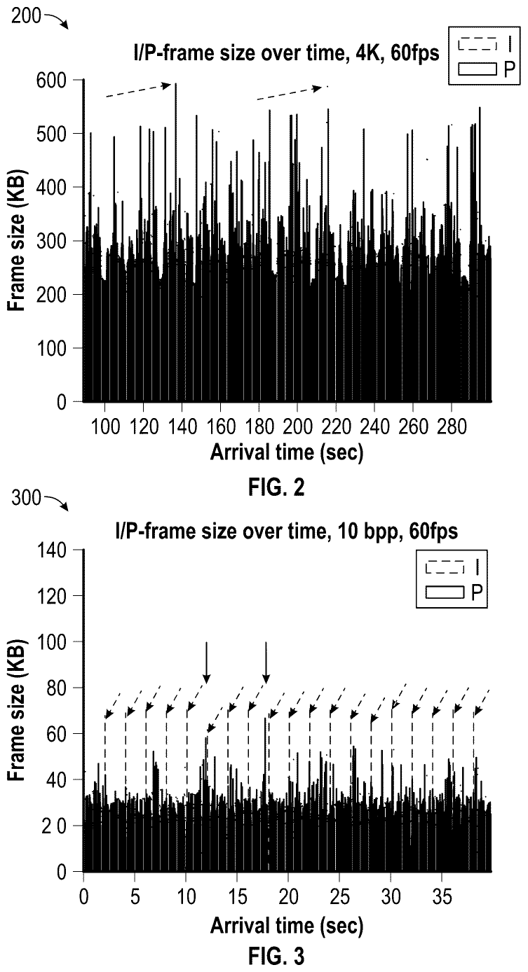

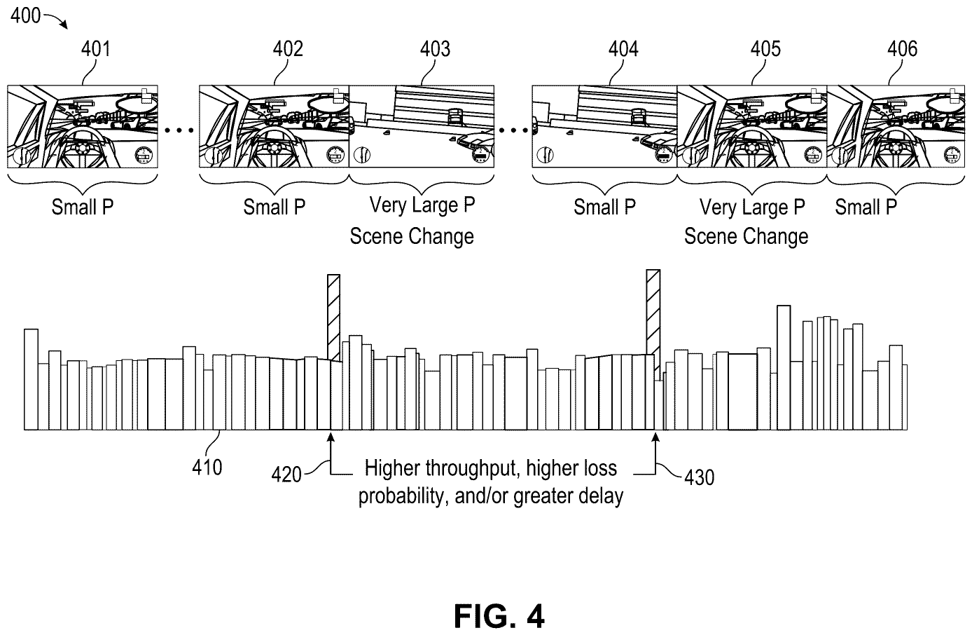

As demonstrated, for example, in FIGS. 2-4, technical challenges and solutions are provided for encoding video (e.g., for cloud gaming environments). For example, when large P-pictures are generated during scene changes, spikes in bandwidth usage may occur. Advanced video coding (AVC) at 4K resolutionand 60 Hz refresh rate may be provided, resulting in relatively high bitrate requirements. FIG. 2 depicts a graph 200 of sizes of P-pictures in a cloud gaming environment over time, in accordance with some embodiments of the disclosure. A GOP structure is utilized with all P-pictures following the I-picture. The graph 200 shows very large P-pictures being generated in a cloud gaming environment, which, depending on the difference from one picture to the next, may or may not generate a very large amount of data for the encoding of that picture. Note there are two frames in this example that are about 600 KB in frame size (marked with arrows). This size would be typical at a scene change as described herein. The encoded video in this example (also shown, e.g., in FIG. 4) is encoded in accordance with advanced video coding (AVC) (i.e., H.264 or MPEG-4 Part 10) at a resolution of approximately 4000 pixels horizontally (i.e., 4K), at a refresh rate of about 60 Hz, and at a bitrate of about 85 Mbps. Since this represents extremely low-latency delivery with a minimal buffer size, delivery of about 600 KB in about 16.67 milliseconds results in a spike in bandwidth of about (600,000×8)×60=288,000,000 or about 288 Mbps. The video will average over time to about 85 Mbps and depending on the buffer model of the client device, this would not pose a problem since many frames will be much smaller in size, allowing the buffer to not drain completely and rebuild on smaller size frames. Other bitrates were evaluated. In all the tested bitrates, the extreme spike in bitrate compared to the encoder bitrate shown as frame size was the same at scene changes. Large frames were generated, for example, by changing the driver view. It is noted that this same problem exists in all codecs (e.g., AVC, HEVC, AV1, VP9, or the like) including the latest in the state of the art (e.g., VVC, or the like).

FIG. 3 depicts a graph 300 of I-pictures in a cloud gaming environment with the GOP structure where the GOP size is about two seconds, in accordance with some embodiments of the disclosure. In this example, an I-picture is created and delivered (e.g., to the client device) every two seconds. The I-picture sizes are marked with 19 arrows, and the P-picture sizes are shown otherwise. In this example, the video is an analysis of a clip captured during a game that was processed at 1080p, 60 Hz, with AVC encoding at 10 Mbps. Note that a size of most of the I-pictures is greater than most P-pictures. I-pictures are often much larger than predicted pictures. This particular game clip also contains numerous large P-pictures as well. There are two cases near the sixth I-picture and near the ninth I-picture where the P-pictures are as large or larger than the I-picture (marked with two vertical arrows), which indicates, in this example, a scene change. This example did not include a user changing their view, e.g., the user was using the same viewpoint perspective, so this example is not as extreme as the racing game example of FIG. 4.

FIG. 4 is an example of a racing game showing an example of a scene change at the third picture below which will result in a very large Predicted encoded picture as shown in FIG. 2 above. In the racing game, a difference from one frame to the next can require relatively high and/or impactful levels of bandwidth usage. Some racing games allow a user playing the game to switch views, for example, from the front windshield to a left, right, or rear view. The difference from one frame to the next will cause the picture sizes to increase dramatically. A series of frames are shown in FIG. 4. The series is an example of two scene changes causing very large P-picture sizes to be generated on the encoded first frame at each scene change.

For example, FIG. 4 depicts an example of an instant scene change 400 resulting in a very large predicted coded picture (P-picture) and a corresponding chart 410 of arrival time versus frame size, in accordance with some embodiments of the disclosure. The scene change 400 includes, for example, a first frame 401 and a second frame 402 depicting a first-person viewpoint of a driver (corresponding with the gamer). There may be additional frames (depicted with an ellipsis) between the first frame 401 and the second frame 402. The corresponding chart 410 of arrival time (x-axis) versus frame size (y-axis) shows a relatively small difference between frames 401 and 402. Whereas, for example, if a user selects a viewpoint change, e.g., a switch from the first-person viewpoint of the driver at the second frame 402 to the driver checking their right side in a third frame 403, an extremely large P-picture 420 is generated due to the scene change. The extremely large P-picture 420 is associated with higher throughput, suffers higher loss probability, and/or suffers greater delay resulting in late arrival (e.g., to the client device), and the present disclosure helps to address these issues.

As above, there may be additional frames (depicted with an ellipsis) between the third frame 403 and a fourth frame 404, where the viewpoint may remain on the driver checking their right side. Again, the corresponding chart 410 shows a relatively small difference between frames 403 and 404. If, as in this example, the driver selects another viewpoint change, e.g., a switch from the driver checking their right side in the fourth frame 404 back to the first-person viewpoint of the driver at a fifth frame 405, again, an extremely large P-picture 430 is generated due to the scene change. A subsequent frame, a sixth frame 406, continues in this example with a relatively small difference between frames 405 and 406. In some approaches, the extremely large P-picture 430 utilizes higher throughput, suffers higher loss probability, and/or suffers greater delay associated with such scene changes.

To further understand the challenges in encoding video at an extremely low bitrate, some background information is provided herein to explain one reason for a very large frame size. A high-level architecture of a video encoder is provided. Descriptions are provided herein (e.g., at FIGS. 5 and 6) of major components of the video encoder. A current video frame (f(n)) is a video frame currently being processed by the encoder. A reference video frame (f(n−1)) is a previous video frame that has already been encoded and is used as a reference for predicting the current frame. Intra prediction performs prediction based on the spatial redundancy within the current frame. Intra prediction uses information from neighboring blocks within the same frame. Inter prediction performs prediction based on the temporal redundancy between the current frame and the reference frame (f(n−1)). Intra prediction uses motion estimation and compensation techniques. A mode selector decides whether to use intra prediction or inter prediction for encoding the current block of the frame. The mode selector selects the mode that results in the best compression efficiency. Within a frame, the mode selection can be applied to intra or inter coding of a macroblock. Transformation and quantization refer to a state, after prediction, in which a residual (e.g., a difference between the actual block and the predicted block) is transformed using techniques like discrete cosine transform (DCT) and then quantized to reduce the number of bits required to represent the data. Context-adaptive variable-length coding (CAVL) performs entropy coding on the quantized coefficients to further compress the data by exploiting statistical redundancies. Context adaptive binary arithmetic coding (CABAC) is another process for entropy coding, and, in the following discussion, CAVLC is used as an example. An Encoded Stream is output of the CAVLC block and is the final compressed bitstream that can be transmitted or stored. Inv (erse) transformation and quantization perform inverse operations of the transformation and quantization blocks to reconstruct the residual signal. A reconstructed video frame (f(n)) refers to the residual being added back to the predicted frame (either intra or inter) to reconstruct the current frame, which will be used as the reference frame for the next frame in the sequence.

For example, the video encoder receives an initial QP value for setting a desired quality for the encoded video. The initial QP value may, for example, be set to always have a set video quality regardless of the complexity of residue (difference after motion compensation) from picture to picture. As a result, an initial QP value of 15, as an example, may generate extremely large encoded pictures or fairly small encoded pictures depending on the motion-compensated difference between the current frame and the previous frame. The video encoder itself does not guarantee to operate and output a desired or capped bitrate. For example, in a single pass encoding for ultra-low-latency streaming, unknown picture characteristics contribute to less predictable resultant picture size. As used herein, for example, a “raw frame” comprises unprocessed, original data (e.g., captured by a camera, generated by a game engine, or the like). The raw frame contains all the pixel information without any compression or encoding applied. Also, for example, an “actual frame” refers to a raw frame once such frame is received (e.g., at a predictor or an encoder) for processing and is to be contrasted with a predicted frame, which is defined herein. The actual frame may refer to a raw or uncompressed frame to-be-encoded. Further, for example, a “compressed frame” is a frame that has undergone compression, e.g., to reduce a file size. Compression can be lossy (some data is lost to reduce size) or lossless (no data is lost). Compression techniques remove redundant information within the frame or between frames. That is, compression is the process of reducing the size of the data. Compression can be part of encoding but focuses specifically on minimizing file size by removing redundant information. In addition, for example, in many uses, an “uncompressed frame” is, generally speaking, any frame to which compression has not been applied. In some uses, the uncompressed frame may be a frame that has been decompressed back to its original state after being compressed. In such instances, the uncompressed frame may closely resemble the raw frame, though in the case of lossy compression, some quality may be lost. Moreover, for example, an “encoded frame” is a frame that has been processed by a codec (coder-decoder) to convert the frame into a specific format suitable for storage or transmission. Encoding, as noted herein, typically comprises compression as part of the process to reduce file size. That is, encoding is a broader process of converting raw video data into a digital format that may include compression but also may involve formatting the data for storage or transmission. Furthermore, for example, a “decoded frame” is a frame that has been converted back from an encoded format to a format that can be displayed or further processed. Decoding comprises decompressing the data and reconstructing the frame. Additionally, for example, terms such as “past,” “current,” “future” (or the like) refer to frames respectively before, during, or after an estimation, prediction and/or encoding process, as is reasonably inferred from context. Still further, for example, a future frame and an “upcoming frame” may be used interchangeably. Even further, for example, a “next frame” refers to a future frame that is, e.g., immediately following a current frame in a sequence of frames.

Performance of residue complexity estimation is improved. For example, residue complexity estimation is used to adjust encoder settings in the context of video encoding for low-latency streaming, enabling improved adjustments to the encoder in anticipation of the estimated complexity of residuals for upcoming frames. Also, for example, techniques associated with video compression are provided to analyze complexity of frame-to-frame changes, enabling better and faster configuration of encoders. The estimation of residual complexity informs encoder settings. See, for example, Phillips et al. and Mathai et al., which are described in greater detail herein.

As a general matter, it may be desirable to update settings of an encoder for a sequence of images during the encoding process. For example, in some approaches, a sequence of frames may be candidates for encoding. A second frame in the sequence is predicted based on a known first frame using frame-level prediction. This predicted frame is then compared to the actual second frame, providing an estimated residual associated with the second frame. The encoder is then updated based on the estimated residual. In general, the more complex the change between the first and second frame, the more significant the estimated residual may be. As a result, the nature of this estimated residual may inform how the encoder should be configured (e.g., the number of encoders used might be zero, and a smaller QP may be possible without negatively affecting video quality).

In some embodiments, a similar process is carried out. However, for example, instead of comparing the frame-level predicted frame (of the second frame) to the actual second frame, the frame-level predicted frame is compared to a BBP frame for the second frame. The BBP frame for the second frame is predicted based on one or more previous BBP frames that are generated by the encoder during the encoding process. Note, BBP tends to yield better predictions than frame-level predictions since its estimation assumes block-based prediction. As a result, the BBP may be thought of as a proxy or substitute for the actual frame during the residue complexity estimation, enabling said estimation before the actual second frame is available (thus enabling faster configuration of the encoder).

For example, in video compression, target frames and reference frames play a role in predicting motion and encoding. The target frame is the frame that is currently being processed for encoding. It may be an intra encoded frame (e.g., I-frame) or a predictively encoded frame (e.g., B-frame or P-frame). An intra-coded frame (I-frame) is an independently encoded frame, serving as a standalone reference. It does not rely on any other frames for decoding. A predicted frame (P-frame) uses data from a previous I-frame or another P-frame as a reference to predict and encode only the differences (residue). A bidirectional frame (B-frame) uses both previous and subsequent frames as references, making it highly efficient for compression.

Also, for example, when the target frame is a prediction frame, the goal is to compress it efficiently by using data from previously encoded frames (e.g., reference frames) to predict its content. The prediction frame is typically predicted based on the motion and details in the reference frames. Once encoded, this frame might later serve as a reference for predicting future frames. Further, for example, you might have a video including a scene with a person walking. The next frame in sequence (e.g., the predictively encoded frame) will likely contain the same person in a slightly different position. Rather than encoding the entire frame again, the encoder will predict what the prediction frame looks like based on previous frames and a residue (e.g., represented by a P-frame).

A reference frame is a previously encoded frame that is used to predict future frames. It acts as a reference for the encoder, which calculates differences (e.g., residue) between the target frame and the reference frame. Reference frames are often stored in a decoded picture buffer (DPB), so that the reference frames can be reused multiple times to predict subsequent frames. A reference frame may be an I-frame, a P-frame, or a B-frame.

The residual (or residue) represents the differences between a predicted frame and the target frame. A P-frame carries a residual, representing the difference between the predicted frame (predicted from the reference frames) and the actual or target frame to be displayed. For example, a sequence of frames may include a first frame, I-frame I1, and a second frame, P-frame P2, referencing I1. After receiving these frames, the decoder generates the first frame by decoding I1. Then, the decoder will generate a predicted frame from I1 (representing a prediction of the second frame); it will then apply the residual carried by P2 to the predicted frame to produce the final decoded second frame.

One purpose of the residual is to capture the parts of the target frame that could not be accurately predicted from reference frames. In most modern video compression systems, frames are not encoded in their entirety; instead, a reference frame is used to predict the content of the target frame. The residual is the difference between the predicted frame and the actual target frame. It contains the prediction errors—that is, the details and movements that the prediction could not accurately estimate. For example, imagine a video of a person walking across a background. The encoder will try to predict the next frame using the reference frames. However, slight changes in the person's position or small movements, such as the swinging of arms, might not be perfectly predicted. These differences between the predicted and actual target frame are captured in the residual.

In some embodiments, as detailed herein, performance of residue complexity estimation in video compression for low-latency streaming is improved. For example, a system is provided to enhance residue complexity estimation with block-based motion estimation techniques to substitute a BBP frame for an actual frame during the estimation process prior to the actual frame being available. The goal is to accurately predict how much complexity (i.e., motion and texture changes) will exist between previous frames and an upcoming frame, allowing the encoder to adjust its resources (e.g., bitrate, QPs, or the like) in advance. Note that the more complex the difference between the two frames, the more information carried by the residual or P-frame to adequately represent the differences between the frames. Said another way, when significant change occurs between a first and a second frame, the less predictive the first frame is of the second frame. It is noted, regarding frame-based motion estimation, described in greater detail below, that motion estimation is not used to generate the prediction frame. In some examples, the frame-based approach is intrinsically in the module (e.g., neural model-based) that takes in multiple previous frames and predicts an upcoming frame.

For example, in frame-based motion estimation, a system analyzes the overall motion or transformation of the entire frame between a reference frame and the current frame (e.g., a target frame). It does this by estimating a global motion model that captures how the content of the frame has changed. One goal is to find the best transformation that describes the change from the reference frame to the target frame.

Once a global motion model is estimated, the next frame is predicted by applying this global transformation to the reference frame. The predicted frame is then compared with the actual target frame to calculate the residual (the difference between the predicted and actual frames). If the prediction is accurate, the residual will be small, and the encoder only transmits the small difference (residual) between the two frames. If the prediction is not accurate (e.g., because there is localized motion that was not captured by the global model), the residual will be larger, and more data is encoded.

Also, for example, in block-based motion estimation, a system divides an upcoming frame into blocks (e.g., 8×8 or 16×16 pixel blocks, or the like) and attempts to predict how each block will change between frames based on the motion of objects in the video. For each block in an upcoming frame, the system searches the previously encoded frames to find the block that best matches it in terms of content. This process is called motion estimation, and the movement of the block between frames is described using a motion vector. Once the best matching block is found in the reference frame, the difference between the predicted block (from the previous frame) and the actual block (in the upcoming frame) is calculated. This difference is the residual or residue, which captures the prediction error. That is, the residual represents the data in the upcoming frame that could not be accurately predicted using only the previous frame.

In some embodiments, prediction of future frames in a video is a challenging task because of relative uncertainty, e.g., especially in the case of forecasting multiple frames over a relatively long period (e.g., a relatively large number of frames in prediction, e.g., predicting the next 10 frames all at once). To model temporal dynamics, advanced methods benefit from diffusion models. For example, diffusion models repeatedly refine one or more predicted future frames with a spatiotemporal-window U-Net. In such prediction of future frames, optimization is focused on ensuring temporal consistency in motion so that a playback of the video renders a visually pleasing experience.

In some embodiments, a video prediction model (e.g., SimVP and/or ExtDM) provides an estimate of a predicted frame for an upcoming frame. For example, the estimate of the predicted frame the upcoming frame is followed by calculating a difference or residue from an actual frame when the actual frame becomes available. Also, for example, the residue is used in the assessment that derives a number of encoders required for encoding a current frame. Further, for example, the residue represents a complexity of residue that is encoded, and the residue thus is used to derive the bitrate or one or more QPs (or a QP range) assigned to one or more encoding instances.

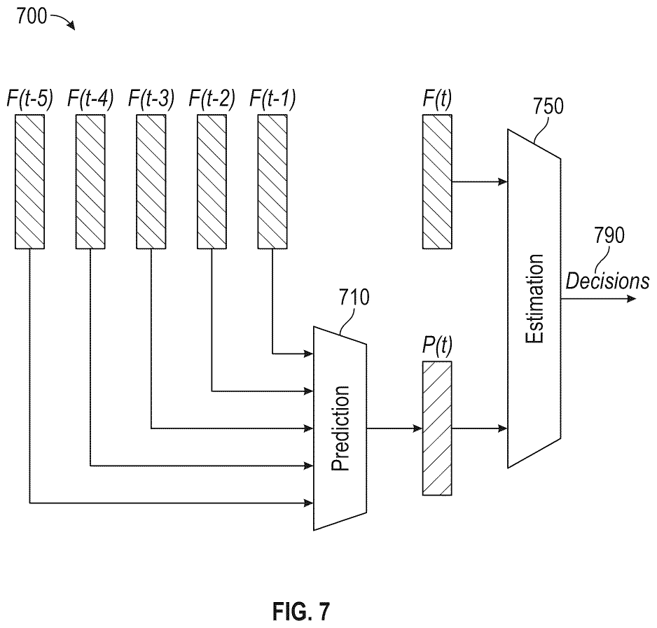

FIG. 7 depicts a system 700 including a prediction module 710 and an estimation module 750 for frame extrapolation and complexity estimation. For example, FIG. 7 shows an example of estimating a predicted frame for an upcoming frame (also referred to herein as a predicted frame) P(t) at time (t) based on frames F(n) where (n=t−d) with (d=1, . . . , N). Also, for example, N is a sliding window size, and in this example, N=5. Further, for example, the predicted frame P(t) is then compared against an actual frame F(t) to derive one or more settings for one or more encoders. In addition, for example, the sliding window size, i.e., a number of past frames to be included in prediction and estimation, and/or a number of encoders to be instantiated, varies as described in Phillips et al. and Mathai et al., described herein. The variation of the number of past frames and/or the number of encoders depends on, e.g., scene changes, system configurations, and other conditions. Without a loss of generality, Phillips et al. and Mathai et al. provide optimization with a sliding window and/or number of encoders determined at each estimation.

For example, the prediction module 710 is configured to receive a number (e.g., five) of frames F(t-5), F(t-4), F(t-3), F(t-2), and F(t-1). Also, for example, the prediction module 710 is configured to determine a predicted frame P(t). Further, for example, the prediction module 710 is configured to determine the predicted frame P(t) based on the frames F(t-5), F(t-4), F(t-3), F(t-2), and F(t-1). In addition, for example, the estimation module 750 is configured to receive an actual frame F(t) and the predicted frame P(t). Moreover, for example, the estimation module 750 is configured to determine one or more decisions 790 based on the actual frame F(t) and the predicted frame P(t).

For example, for the system 700, video prediction and/or extrapolation, e.g., as set forth in Phillips et al. and Mathai et al., are different from estimating a prediction and/or residue for a future frame in video encoding. For example, in video compression, motion prediction from a reference is block-based (and so is motion compensation). In other words, as set forth herein, aggregating all block-based predictions to form a prediction frame generates a representation different from a predicted frame for video playback. For example, sub-pel (i.e., at the fractional pixel level) motion prediction and compensation adds to a complex representation of the block-based prediction frame.

Also, for example, for the system 700, as described herein, the predicted frame P(t) is primarily optimized to ensure temporal consistency in motion and a visually pleasing representation when the video is in playback. This objective is different from estimating a prediction for an upcoming frame in video encoding.

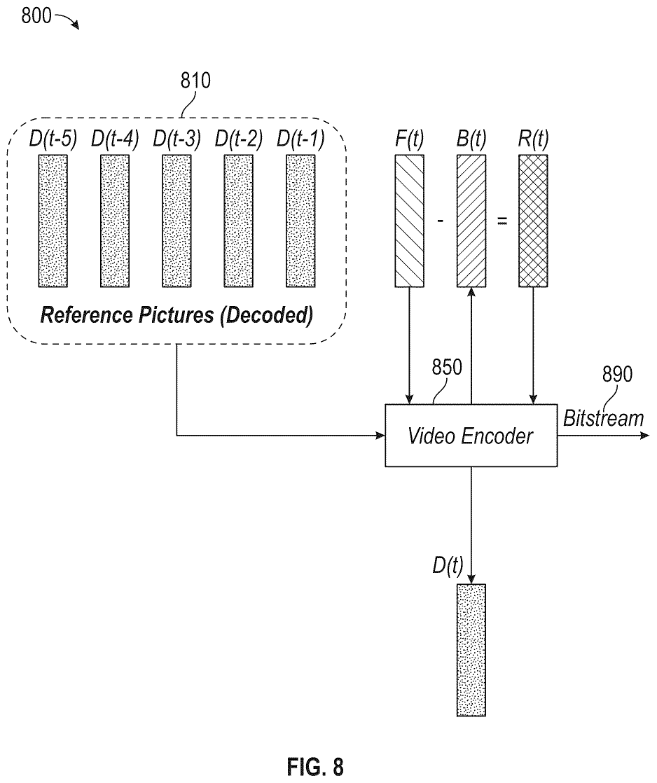

FIG. 8 depicts a system 800 including a video encoder 850 for video encoding, reconstruction, and decoding. For example, in video encoding, a decoding process is provided that generates a reconstructed picture for an input frame. The decoded reference pictures are stored in a decoded picture buffer (DPB) and used in the motion prediction and compensation for the predictive encoding of next frames. Also, for example, FIG. 8 shows that encoding of an actual frame F(t) uses (e.g., decoded) reference pictures (or frames) 810, D(n), where (n=t−d) with (d=1, . . . , N). B(t) is a block-based prediction frame aggregated from block-based motion estimation. R(t) is the aggregate residue (e.g., (F(t)−B(t)=R(t)) after block-based motion compensation and then encoded, block-by-block, to generate the bitstream. The process of FIG. 8 results in an encoded/decoded frame D(t) and its encoded bitstream 890.

For example, the video encoder 850 is configured to receive at least one of the reference pictures 810, the actual frame F(t), the aggregate residue R(t) (after calculation), combinations of the same, or the like. Also, for example, the video encoder 850 is configured to determine the aggregate residue R(t) in accordance with F(t)−B(t)=R(t). In other words, the video encoder 850 is configured to determine the block-based prediction frame B(t) as an intermediate step. Further, for example, the video encoder 850 is configured to determine the encoded/decoded frame D(t) and the encoded bitstream 890 based at least in part on at least one of the reference pictures 810, the actual frame F(t), the aggregate residue R(t) (after calculation), combinations of the same, or the like.

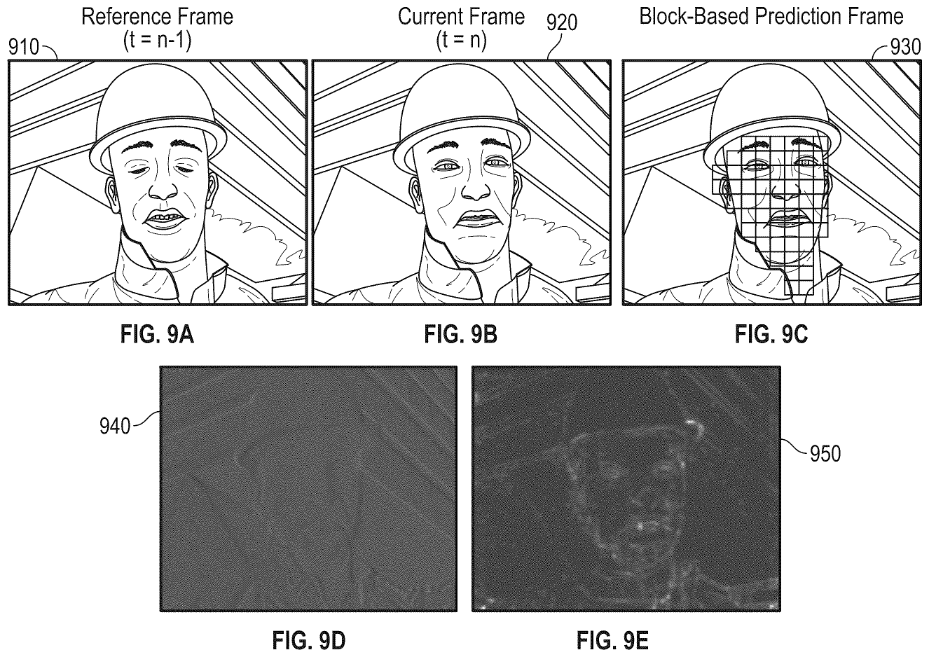

FIG. 9A depicts a reference frame 910 for block-based prediction. FIG. 9B depicts a current frame 920 for block-based prediction. FIG. 9C depicts a block-based prediction frame 930 for block-based prediction. For example, the block-based prediction frame 930 is an aggregate of all the prediction blocks selected in motion estimation between the reference frame 910 and current frames including the current frame 920. The visual appearance of the block-based prediction frame 930 in FIG. 9C is far from acceptable for video playback. Rather, the objective of motion estimation is to minimize the residue for each block after motion compensation so that the encoded bits are minimized for the block. The quality or visual appearance of each prediction is generally not determinative.

FIG. 9D depicts a comparison 940 of frame differences (or residues) for block-based prediction, wherein the frame difference is from a shift of one pixel. FIG. 9E depicts a comparison 950 of frame differences (or residues) for block-based prediction, wherein the frame difference is after block-based compensation. For example, in FIG. 9D, the residue is the difference between FIG. 9B and its version shifted by one pixel horizontally. Also, for example, in FIG. 9E, the residue is the difference between FIG. 9B and FIG. 9C. The complexity or signal energy of FIG. 9D is much higher than FIG. 9E. In other words, the estimates of encoded bits correspondingly exhibit notable variation.

In some embodiments, predictions are provided for video compression for low-latency or ultra-low-latency streaming, e.g., cloud gaming, live events streaming, or the like. The improved estimation benefits optimization of encoder settings and therefore encoding resource allocation. For example, predictions are provided for video compression for low-latency or ultra-low-latency streaming provided by a service provider that offers a low-latency encoding service.

Also, for example, predictions are provided for video compression for low-latency or ultra-low-latency streaming via an API for a low-latency encoding service.

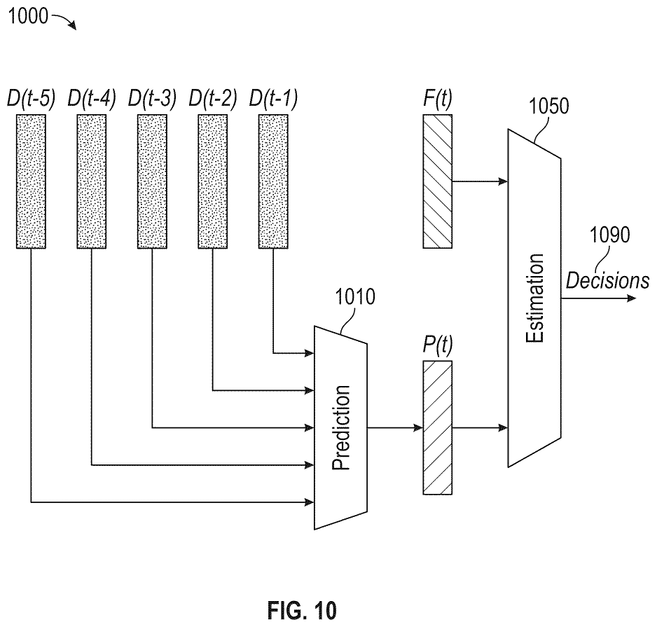

FIG. 10 depicts a system 1000 including a prediction module 1010 and an estimation module 1050 for frame extrapolation based on decoded pictures for frame predicting in video compression. For example, in video compression, motion prediction is block-based and so is the motion compensation, which are all dependent on the encoded/decoded reference pictures. In other words, there is no dependency on the uncompressed frames, which are not available at the decoder. Also, for example, the use of reconstructed frames D(n), where (n=t−d) with (d=1, . . . , N), in the prediction of P(t), as shown in FIG. 10, is effective in generating a representation of a target frame. Further, for example, the system 1000 is provided in the context of video compression, and the optimization is focused on estimating a prediction aggregated from the reconstructed reference frames only.

For example, the prediction module 1010 is configured to receive a number (e.g., five) of reference frames D(t-5), D(t-4), D(t-3), D(t-2), and D(t-1). Also, for example, the prediction module 1010 is configured to determine a predicted frame P(t). Further, for example, the prediction module 1010 is configured to determine the predicted frame P(t) based on the frames D (t-5), D(t-4), D(t-3), D(t-2), and D(t-1). In addition, for example, the estimation module 1050 is configured to receive an actual frame F(t) and the predicted frame P(t). Moreover, for example, the estimation module 1050 is configured to determine one or more decisions 1090 based on the actual frame F(t) and the predicted frame P(t).

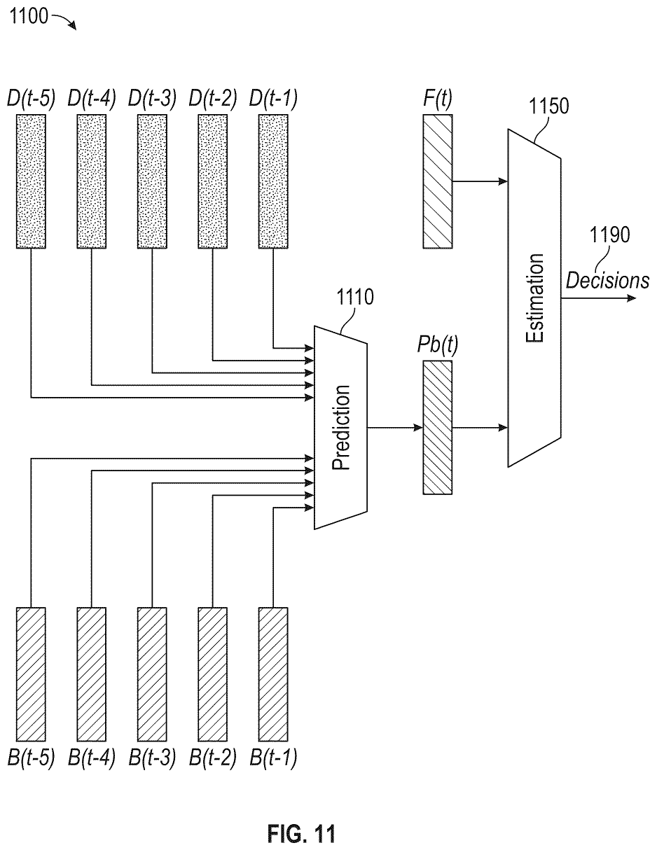

FIG. 11 depicts a system 1100 including a prediction module 1110 and an estimation module 1150 for estimation of aggregated block-based prediction pictures Pb(t) for an upcoming frame in video compression. The use of decoded reference frames in FIG. 10 lacks the consideration of block-based prediction. As illustrated in FIGS. 9A-9C, aggregating all the block-based prediction to form a prediction frame generates a representation notably different from a frame-based prediction. FIG. 11 introduces the input of the block-based prediction frames B(n) where (n=t−d) with (d=1, . . . , N). These frames B(n) are available or readily collected from the encoding of those frames, and there is no additional processing or latency imposed. In this case, the output of prediction becomes the block-based prediction frame Pb(t), which is an improved prediction of P(t) in FIG. 10.

For example, the prediction module 1110 is configured to receive a number (e.g., five) of reference frames D(t-5), D(t-4), D(t-3), D(t-2), and D(t-1), and a number (e.g., five) of block-based prediction frames B(t-5), B(t-4), B(t-3), B(t-2), and B(t-1). Also, for example, the prediction module 1110 is configured to determine a block-based predicted frame Pb(t). Further, for example, the prediction module 1110 is configured to determine the block-based predicted frame Pb(t) based on the reference frames D(t-5), D(t-4), D(t-3), D(t-2), and D(t-1) and the block-based prediction frames B(t-5), B(t-4), B(t-3), B(t-2), and B(t-1). In addition, for example, the estimation module 1150 is configured to receive an actual frame F(t) and the block-based predicted frame Pb(t). Moreover, for example, the estimation module 1150 is configured to determine one or more decisions 1190 based on the actual frame F(t) and the block-based predicted frame Pb(t).

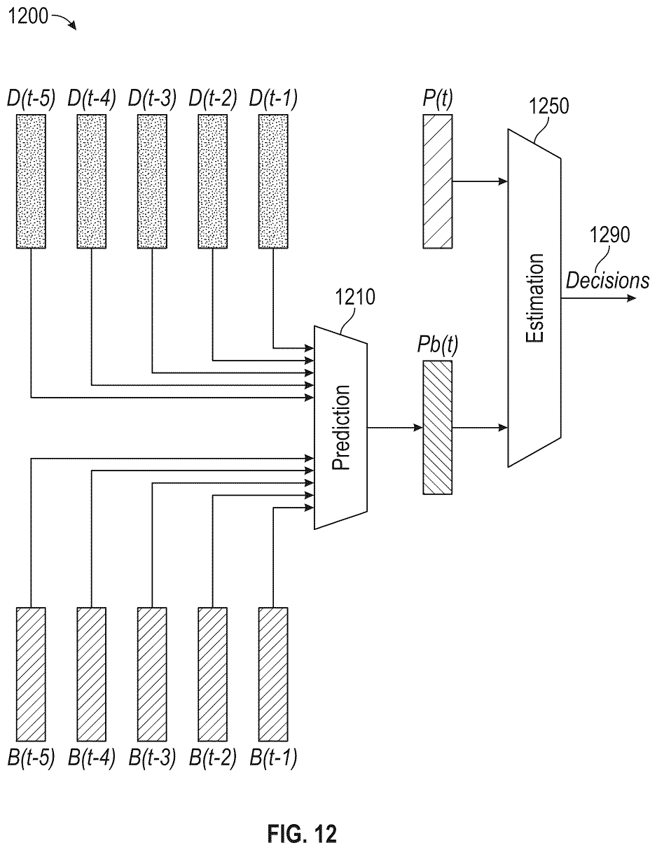

FIG. 12 depicts a system 1200 including a prediction module 1210 and an estimation module 1250 for a difference between a frame-based prediction and an aggregated block-based prediction picture. For example, the frame F(t) in FIG. 11 is replaced by the prediction frame P(t), as shown in FIG. 12. A determination by the estimation module 1250 does not depend on the arrival of (e.g., an actual) frame F(t). In other words, the processing in the estimation module 1250 may complete the decision making (at 1290) and derive encoder settings for encoding F(t) without any delay. The encoding of F(t) may start immediately (e.g., simultaneously or very nearly simultaneously, less than about a millisecond; that is, e.g., the encoder does not perform processing or analysis on the frame prior to encoding the frame) when F(t) becomes available.

For example, the differences between D(n) and B(n) for (n=t−d) with (d=1, . . . , N), as shown in FIG. 12, represent the actually encoded residues of those past frames. The difference between P(t) and Pb(t) is the predicted residue of F(t) when it is input to the encoder and goes through block-based motion estimation and compensation. Hence, the difference between P(t) and Pb(t) is more representative of the residue complexity subject to video encoding.

For example, the prediction module 1210 is configured to receive a number (e.g., five) of reference frames D(t-5), D(t-4), D(t-3), D(t-2), and D(t-1), and a number (e.g., five) of block-based prediction frames B(t-5), B(t-4), B(t-3), B(t-2), and B(t-1). Also, for example, the prediction module 1210 is configured to determine a block-based predicted frame Pb(t). Further, for example, the prediction module 1210 is configured to determine the block-based predicted frame Pb(t) based on the reference frames D(t-5), D(t-4), D(t-3), D(t-2), and D(t-1) and the block-based prediction frames B(t-5), B(t-4), B(t-3), B(t-2), and B(t-1). In addition, for example, the estimation module 1250 is configured to receive a prediction frame P(t) and the block-based predicted frame Pb(t). Moreover, for example, the estimation module 1250 is configured to determine one or more decisions 1290 based on the prediction frame P(t) and the block-based predicted frame Pb(t).

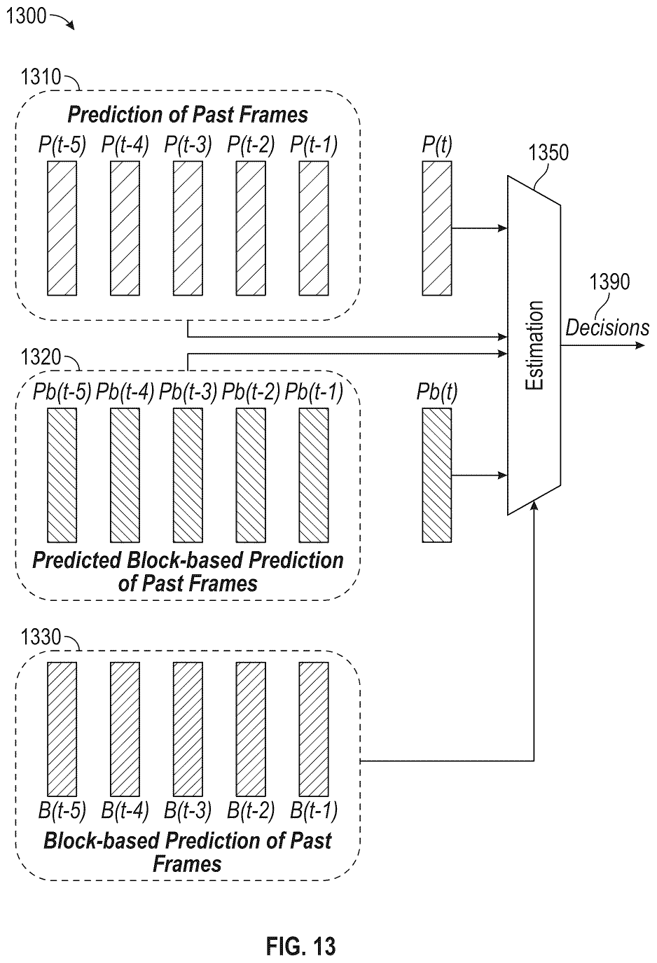

FIG. 13 depicts a system 1300 including an estimation module 1350 for a difference between a frame-based prediction and an aggregated block-based prediction picture including a prediction of past frames 1310, a predicted block-based prediction of past frames 1320, and a block-based prediction of past frames 1330. There are different ways in constructing the input and output of the prediction and estimation that will influence both training and inference for neural models configured to perform prediction and estimation. For example, FIG. 13 shows another variant of the estimation module 1350. The input of Pb(n) for (n=t−d) with (d=1, . . . , N) represents the predicted block-based prediction of the past frames 1320. Note that B(n) are the actual statistics from encoding, while P(n) and Pb(n) are from the prediction module (e.g., as described in other embodiments). For frames (n=t−d), those are available at the time of predicting for frame F(t). The estimation module 1350 in FIG. 13 considers the performance of prediction, reinforced by the feedback of actual block-based prediction B(n) from the video encoding.

Also, for example, the decisions 1290 and 1390 from the estimation modules 1250 and 1350 in FIGS. 12 and 13 are independent of F(t). This is useful when F(t) is not a scene change, and the estimated derivatives across consecutive frames represent consistency in the residues through motion estimation. If F(t) is detected as a scene change, the prediction results will become less correlated and thus the encoder settings may be subject to a refresh.

Further, for example, prediction and estimation are not necessarily limited to using neural networks. Conventional solutions based on closed form equations and formula are also feasible. For example, training of neural networks or curve fitting for parameters in equations are based at least in part on a collection of data (e.g., optimized data).

For example, the estimation module 1350 is configured to receive at least one of a prediction frame P(t); a number (e.g., five) of predictions of past frames P(t-5), P(t-4), P(t-3), P(t-2), and P(t-1) 1310; a number (e.g., five) of predicted block-based prediction (e.g., of past) frames Pb(t-5), Pb(t-4), Pb(t-3), Pb(t-2), and Pb(t-1) 1320; a predicted block-based prediction frame Pb(t); a number (e.g., five) of block-based prediction frames B(t-5), B(t-4), B(t-3), B(t-2), and B(t-1) 1330; combinations of the same; or the like. Also, for example, the estimation module 1350 is configured to determine one or more decisions 1390 based on the prediction frame P(t) the predictions of past frames 1310; the predicted block-based prediction (e.g., of past) frames 1320; the predicted block-based prediction frame Pb(t); and the block-based prediction frames 1330.

In some embodiments, a method comprises at least one of: encoding a sequence of frames using one or more encoders; predicting a future frame based at least in part on previously encoded frames; generating a predicted frame by comparing information from multiple previously encoded frames; estimating a residual complexity of the future frame by comparing different predicted frames; configuring the one or more encoders based at least in part on the estimated residual complexity before encoding the future frame; encoding the future frame using the configured one or more encoders; combinations of the same; or the like. For example, the comparing comprises analyzing motion information and comparing previous frames. Also, for example, the comparing comprises calculating a difference metric to indicate the complexity. Further, for example, the configuring the one or more encoders comprises adjusting parameters based at least in part on the estimated residual complexity. In addition, for example, the configuring the one or more encoders comprises determining a number of encoders based at least in part on the estimated residual complexity. Moreover, for example, the method comprises comprising dynamically adjusting the number of encoders. Furthermore, for example, the generating the predicted frame uses a trained model. Additionally, for example, the generating the predicted frame uses a trained neural network. Still further, for example, the generating the predicted frame comprises spatial prediction. Even further, for example, the generating the predicted frame comprises temporal prediction.

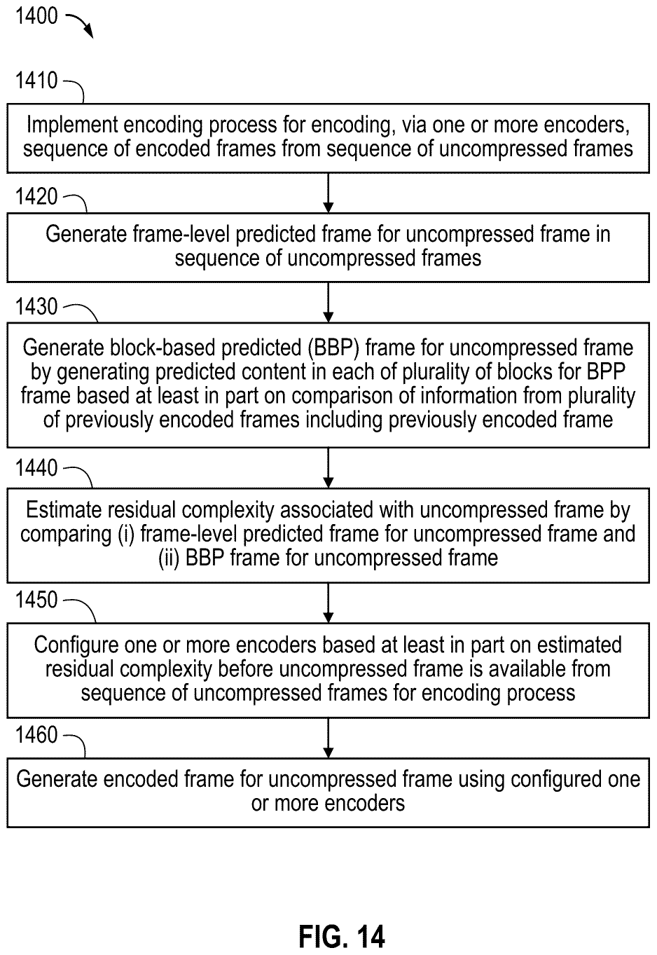

FIG. 14 is a flowchart of a method 1400 for frame-level and block-based prediction for video compression. For example, the method 1400 comprises at least one of: implementing 1410 an encoding process for encoding, via one or more encoders, a sequence of encoded frames from a sequence of uncompressed frames; generating 1420 a frame-level predicted frame for an uncompressed frame in the sequence of uncompressed frames, wherein the uncompressed frame is upcoming in the sequence of uncompressed frames and the uncompressed frame does not yet have a corresponding encoded frame, based at least in part on a previously encoded frame that was encoded based at least in part on a previous uncompressed frame; generating 1430 a block-based predicted (BBP) frame for the uncompressed frame by generating predicted content in each of a plurality of blocks for the BPP frame based at least in part on a comparison of information from a plurality of previously encoded frames including the previously encoded frame; estimating 1440 a residual complexity associated with the uncompressed frame by comparing (i) the frame-level predicted frame for the uncompressed frame and (ii) the BBP frame for the uncompressed frame; configuring 1450 the one or more encoders based at least in part on the estimated residual complexity before the uncompressed frame is available from the sequence of uncompressed frames for the encoding process; generating 1460 an encoded frame for the uncompressed frame using the configured one or more encoders; combinations of the same; or the like.

Also, for example, the comparison of the information from the plurality of previously encoded frames including the previously encoded frame comprises comparison of (i) motion information determined by analyzing movement of one or more of the plurality of blocks across one or more decoded frames for previously encoded frames, and (ii) a comparison between (a) a previous one or more uncompressed frames in the sequence of uncompressed frames for which encoded frames have been generated and (b) a previous BBP frame generated during the encoding process for each of the previous one or more uncompressed frames. Further, for example, the (ii) comparison between (a) the previous one or more uncompressed frames and (b) the previous BBP frame comprises calculating a difference metric indicative of the residual complexity. In addition, for example, the configuring 1450 the one or more encoders comprises adjusting a QP based at least in part on the estimated residual complexity. Moreover, for example, the configuring 1450 the one or more encoders comprises determining a number of encoders required based at least in part on the estimated residual complexity. Furthermore, for example, the method 1400 comprises dynamically adjusting the number of encoders.

Additionally, for example, the generating 1430 the BBP frame is performed using a trained model. Still further, for example, the generating 1430 the BBP frame is performed using a trained neural network. Even further, for example, the generating 1430 the BBP frame comprises spatial prediction. Yet further, for example, the generating 1430 the BBP frame comprises temporal prediction.

In some embodiments, a method comprises at least one of: encoding a sequence of frames using one or more encoders; generating motion cues from the frames using an autoencoder; predicting future motion cues using a distribution model; estimating a complexity of a future frame based at least in part on the predicted motion cues; encoding the future frame based at least in part on the estimated complexity to reduce latency; combinations of the same; or the like. For example, the method comprises generating optical flow and occlusion maps. Also, for example, the distribution model is Gaussian. Further, for example, the method comprises dynamically adjusting a number of the one or more encoders based at least in part on the estimated complexity. Further, for example, the encoding is performed by parallel encoders. In addition, for example, the method comprises refining motion cues with a neural network. Moreover, for example, the estimated complexity determines encoding decisions. Furthermore, for example, the method comprises adjusting initial parameters of the one or more encoders based at least in part on the estimated complexity. Additionally, for example, the method comprises a transformation between frames and motion cues. Still further, for example, the method comprises adjusting encoding parameters based at least in part on real-time feedback.

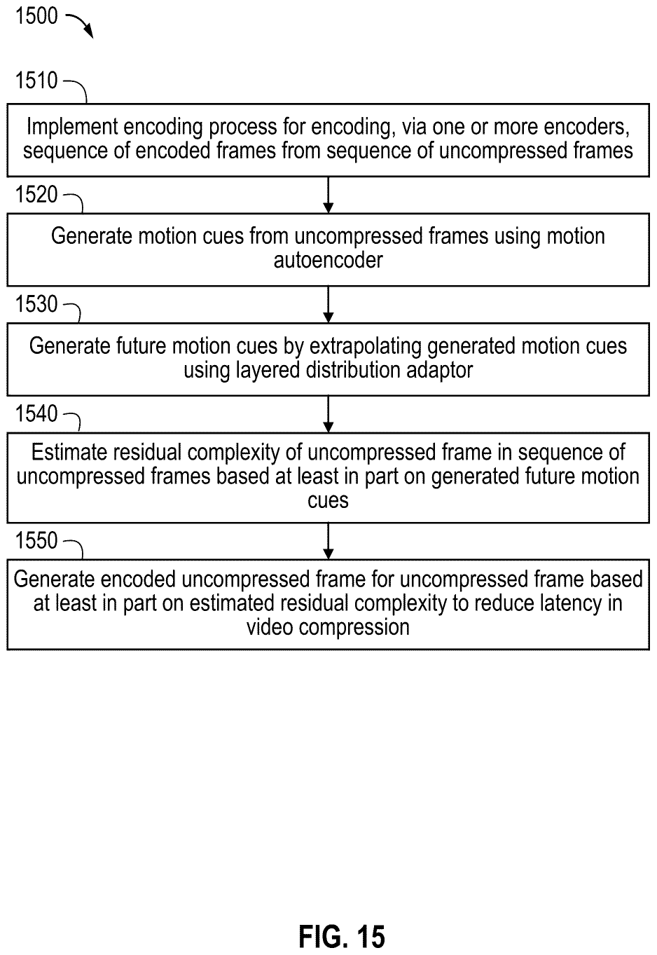

FIG. 15 is a flowchart of a method 1500 for a motion autoencoder and layered distribution for latency reduction. For example, the method 1500 comprises at least one of: implementing 1510 an encoding process for encoding, via one or more encoders, a sequence of encoded frames from a sequence of uncompressed frames; generating 1520 motion cues from the uncompressed frames using a motion autoencoder; generating 1530 future motion cues by extrapolating the generated motion cues using a layered distribution adaptor; estimating 1540 a residual complexity of an uncompressed frame in the sequence of uncompressed frames, wherein the uncompressed frame is upcoming in the sequence of uncompressed frames and the uncompressed frame does not yet have a corresponding encoded frame, based at least in part on the generated future motion cues; generating 1550 an encoded uncompressed frame for the uncompressed frame based at least in part on the estimated residual complexity to reduce latency in video compression; combinations of the same; or the like. Also, for example, the method 1500 comprises generating, with the motion autoencoder, optical flow and occlusion maps from the sequence of uncompressed frames. Further, for example, the layered distribution adaptor comprises a Gaussian distribution model to extrapolate the generated future motion cues. In addition, for example, the method 1500 comprises dynamically adjusting a number of the one or more encoders based at least in part on the estimated residual complexity. Moreover, for example, the generating of the encoded uncompressed frame is performed by frame-synced parallel encoders. Furthermore, for example, the method 1500 comprises refining the generated future motion cues with a spatiotemporal-window U-Net. Additionally, for example, the estimated residual complexity determines encoding decisions before the uncompressed frame arrives at the one or more encoders. Still further, for example, the method 1500 comprises adjusting one or more initial QP values of the one or more encoders based at least in part on the estimated residual complexity. Even further, for example, the method 1500 comprises performing, with the motion autoencoder, a bijection transformation between the sequence of uncompressed frames and the motion cues. Yet further, for example, the method 1500 comprises adjusting one or more encoding parameters based at least in part on real-time feedback from a client device.

In some embodiments, a method comprises at least one of: performing motion prediction and compensation for video compression; generating a target frame based at least in part at least in part on a reconstructed frame; performing motion estimation based at least in part on an uncompressed frame and the target frame; combinations of the same; or the like. For example, the motion prediction is based only on the reconstructed frame. Also, for example, the motion prediction uses multiple reconstructed frames. Further, for example, frames are selected based at least in part on temporal proximity. In addition, for example, the method comprises applying motion compensation using motion vectors. Moreover, for example, the method comprises calculating motion vectors with a matching algorithm. Furthermore, for example, the method comprises transmitting motion vectors and residuals to a decoder. Additionally, for example, the residuals represent differences between predicted and encoded blocks. Still further, for example, the method comprises generating a reconstructed frame by decoding a previously encoded frame. Even further, for example, the motion prediction is based at least in part on aggregated predictions from multiple reconstructed frames.

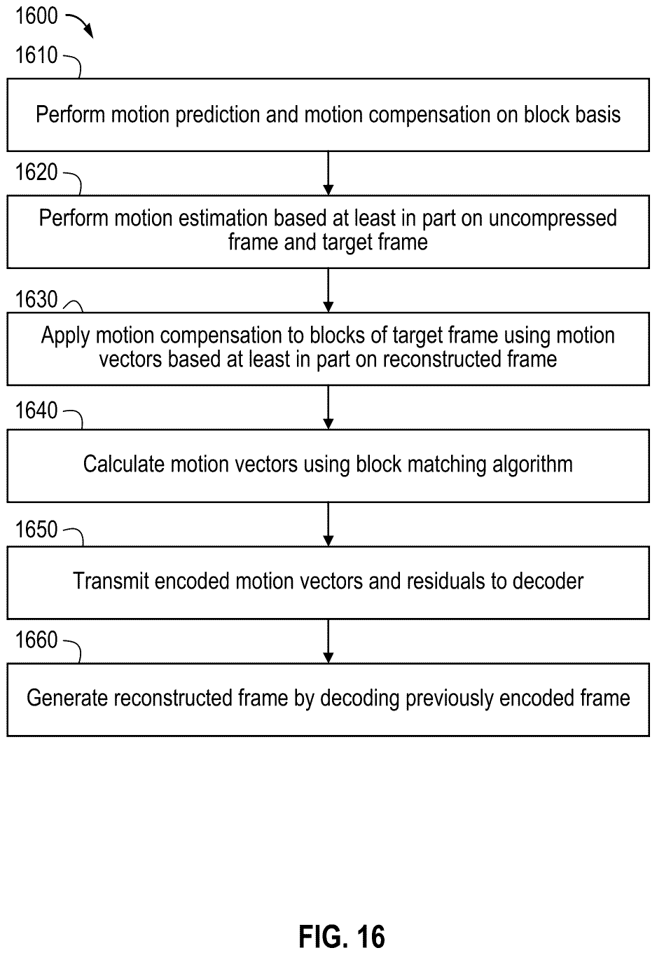

FIG. 16 is a flowchart of a method 1600 for block-based motion prediction and compensation. For example, the method 1600 comprises performing 1610 motion prediction and motion compensation on a block basis, wherein the motion prediction and the motion compensation are dependent on encoded and decoded reference pictures. For example, the motion prediction comprises generating a target frame (P(t)) based at least in part on a reconstructed frame (D(n)). Also, for example, the method 1600 comprises performing 1620 motion estimation based at least in part on an uncompressed frame F(t) and the target frame (P(t)). Further, for example, the motion prediction is generated from the reconstructed frame (D(n)) only, without dependency on an uncompressed frame. In addition, for example, the motion prediction is performed using a plurality of the reconstructed frames (D(n)). Moreover, for example, the plurality of reconstructed frames (D(n)) are selected based at least in part on temporal proximity to the target frame (P(t)). Furthermore, for example, the method 1600 comprises applying 1630 the motion compensation to blocks of the target frame (P(t)) using motion vectors based at least in part on the reconstructed frame (D(n)). Additionally, for example, the method 1600 comprises calculating 1640 the motion vectors using a block matching algorithm. Still further, for example, the method 1600 comprises transmitting 1650 encoded motion vectors and residuals to a decoder. Even further, for example, the residuals represent a difference between predicted blocks and encoded blocks of the target frame (P(t)). Yet further, for example, the method 1600 comprises generating 1660 the reconstructed frame (D(n)) by decoding a previously encoded frame. Further still, for example, the motion prediction of the target frame (P(t)) is based at least in part on aggregated predictions from a plurality of the reconstructed frames (D(n)).

In some embodiments, a method comprises at least one of accessing block-based prediction frames; aggregating the block-based prediction frames to form a combined prediction frame; generating an improved prediction of a target frame using the combined prediction frame and an uncompressed frame; combinations of the same; or the like. For example, the block-based prediction frames are accessed from an encoding process. Also, for example, the improved prediction is generated without additional processing or latency. Further, for example, the method comprises generating the block-based prediction frames based at least in part on decoded reference frames. In addition, for example, the method comprises accessing the decoded reference frames from previously encoded frames. Moreover, for example, the aggregating the block-based prediction frames comprises combining motion vectors and residuals. Furthermore, for example, the method comprises calculating the motion vectors using a block matching algorithm. Additionally, for example, the method comprises reducing estimating for the residual complexity using the combined prediction frame. Still further, for example, the method comprises selecting the block-based prediction frames based at least in part on their temporal proximity to the target frame. Even further, for example, the method comprises prediction of residual complexity, where the prediction of residual complexity minimizes a difference between the combined prediction frame and an encoded target frame.

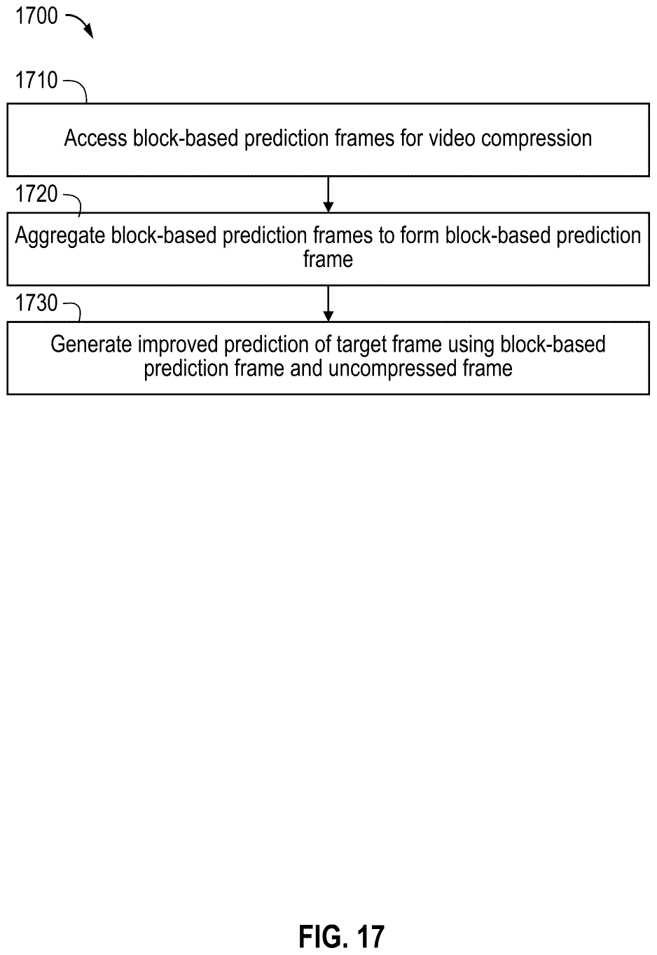

FIG. 17 is a flowchart of a method 1700 aggregating block-based predictions for improved frame prediction. For example, the method 1700 comprises at least one of: accessing 1710 block-based prediction frames (B(n)) for video compression, wherein (n=t−d) with (d=1, . . . , N); aggregating 1720 the block-based prediction frames (B(n)) to form a block-based prediction frame (Pb(t)); generating 1730 an improved prediction of a target frame (P(t)) using the block-based prediction frame (Pb(t)) and an uncompressed frame F(t); combinations of the same; or the like. Also, for example, the block-based prediction frames (B(n)) are available or accessed from encoding of past frames (P(n)). Further, for example, the generating 1730 the improved prediction of the target frame (P(t)) using the block-based prediction frame (Pb(t)) is performed without additional processing or latency. In addition, for example, the method 1700 comprises generating the block-based prediction frames (B(n)) based at least in part on decoded reference frames. Moreover, for example, the method 1700 comprises accessing the decoded reference frames based at least in part on previously encoded frames. Furthermore, for example, the aggregating 1720 the block-based prediction frames (B(n)) comprises combining motion vectors and residuals from multiple blocks. Additionally, for example, the method 1700 comprises calculating the motion vectors with a block matching algorithm. Still further, for example, the method 1700 comprises reducing estimating the residual complexity based at least in part on the block-based prediction frame (Pb(t)). Even further, for example, the method 1700 comprises selecting the block-based prediction frames (B(n)) based at least in part on temporal proximity of the block-based prediction frames (B(n)) to the target frame (P(t)). Yet further, for example, the method 1700 comprises prediction of residual complexity, where the prediction of residual complexity comprises minimizing a difference between the block-based prediction frame (Pb(t)) and an encoded target frame (P(t)).

In some embodiments, a method comprises at least one of: determining differences between reconstructed frames and block-based prediction frames; aggregating the block-based prediction frames to form a combined prediction frame; determining a predicted residue by comparing a prediction frame and the combined prediction frame; generating encoder settings for encoding the frame based at least in part on the prediction frame, and the combined prediction frame; combinations of the same; or the like. For example, the generating the encoder settings comprises determining a number of encoders required based at least in part on the predicted residue. Also, for example, the encoding is initiated immediately upon availability of the frame. Further, for example, the encoder settings comprise QPs and motion vector information. In addition, for example, the encoding comprises block-based motion estimation and compensation. Moreover, for example, the block-based motion estimation and compensation comprise generating motion vectors based at least in part on block-based prediction frames. Furthermore, for example, the method comprises minimizing prediction error based at least in part on the predicted residue. Additionally, for example, the method comprises dynamically adjusting encoding parameters based at least in part on differences between the reconstructed frames and the block-based prediction frames. Still further, for example, the method comprises performing block-based motion estimation and compensation in real-time to reduce latency. Even further, for example, the method comprises adaptively controlling the bitrate of an encoded video bitstream based at least in part on complexity of the predicted residue.

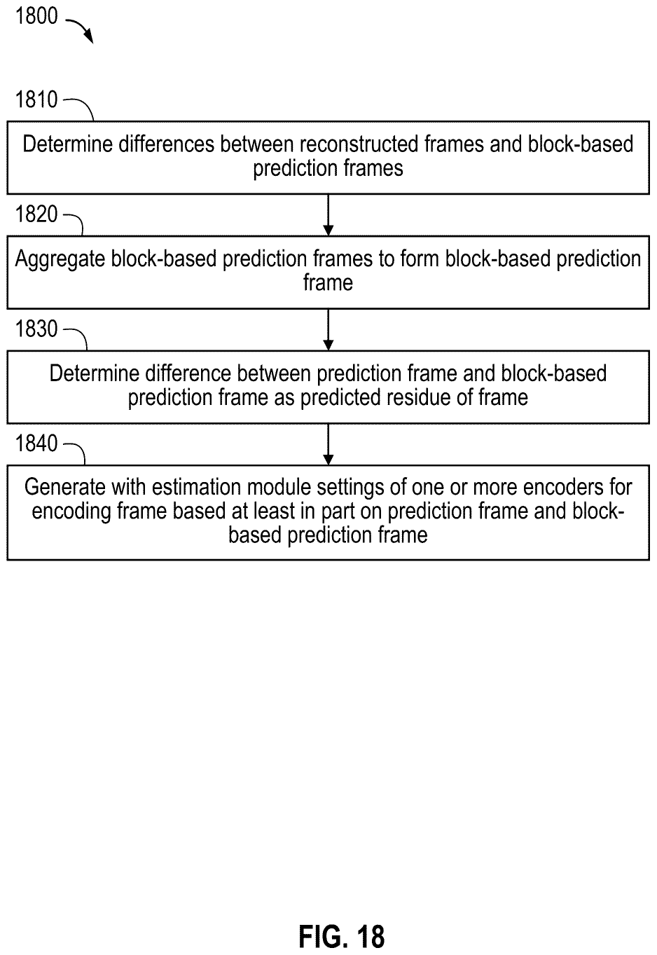

FIG. 18 is a flowchart of a method 1800 for encoding with predicted residue and dynamic adjustment. For example, the method 1800 comprises at least one of: determining 1810 differences between reconstructed frames (D(n)) and block-based prediction frames (B(n)), wherein (n=t−d) with (d=1, . . . , N), and wherein the differences represent encoded residues of previous frames; aggregating 1820 the block-based prediction frames (B(n)) to form a block-based prediction frame (Pb(t)); determining 1830 a difference between a prediction frame (P(t)) and the block-based prediction frame (Pb(t)) as a predicted residue of the frame (F(t)); generating 1840, with the estimation module, settings of an encoder for encoding the frame (F(t)); combinations of the same; or the like. Also, for example, the generating 1860 the settings of the one or more encoders for encoding the frame (F(t)) is performed without dependency on an arrival of the frame (F(t)). Further, for example, the generating 1840, with the estimation module, settings of the one or more encoders for encoding the frame (F(t)) comprises determining a number of encoders required based at least in part on the predicted residue of the frame (F(t)). In addition, for example, the settings of the one or more encoders comprise QPs and motion vector information. Moreover, for example, the encoding of the frame (F(t)) comprises block-based motion estimation and compensation. Furthermore, for example, the block-based motion estimation and compensation comprise generating motion vectors based at least in part on the block-based prediction frames (B(n)). Additionally, for example, the method 1800 comprises minimizing prediction error of the encoding based at least in part on the predicted residue of the frame (F(t)). Still further, for example, the method 1800 comprises dynamically adjusting encoding parameters based at least in part on the differences between the reconstructed frames (D(n)) and the block-based prediction frames (B(n)). Even further, for example, the method 1800 comprises performing the block-based motion estimation and compensation in real-time to reduce latency. Yet further, for example, the method 1800 comprises adaptively controlling a bitrate of an encoded video bitstream based at least in part on a complexity of the predicted residue.

In some embodiments, a method comprises at least one of: accessing information of a prediction frame; accessing information of a prediction of past frames; accessing information of predicted block-based predictions of previous frames; accessing information of a block-based prediction of a frame; accessing information of encoded block-based predictions based at least in part on past frames; determining one or more encoding decisions of one or more encoders based at least in part on the information of: the prediction frame, the prediction of past frames, the predicted block-based predictions of previous frames, the block-based prediction of the frame, and the encoded block-based predictions; detecting scene changes in a current frame from a past frame; determining a setting of the one or more encoders based at least in part on the detected scene changes in the current frame; combinations of the same; or the like. For example, the method comprises constructing input and output for training and inference of neural network models for video compression. Also, for example, the neural network models are trained using historical video compression data. Further, for example, the method comprises generating predicted block-based predictions using motion estimation techniques. In addition, for example, the motion estimation techniques comprise block matching algorithms. Moreover, for example, the method comprises generating encoded block-based predictions based at least in part on previously encoded frames. Furthermore, for example, the method comprises refining the prediction module based at least in part on the feedback from encoded block-based predictions. Additionally, for example, the method comprises dynamically adjusting the encoder settings based at least in part on decisions from an estimation module. Still further, for example, the detecting scene changes triggers a refresh of settings of the estimation module and the encoder settings. Even further, for example, the method comprises maintaining consistency in residues through motion estimation across consecutive frames when no scene change is detected.

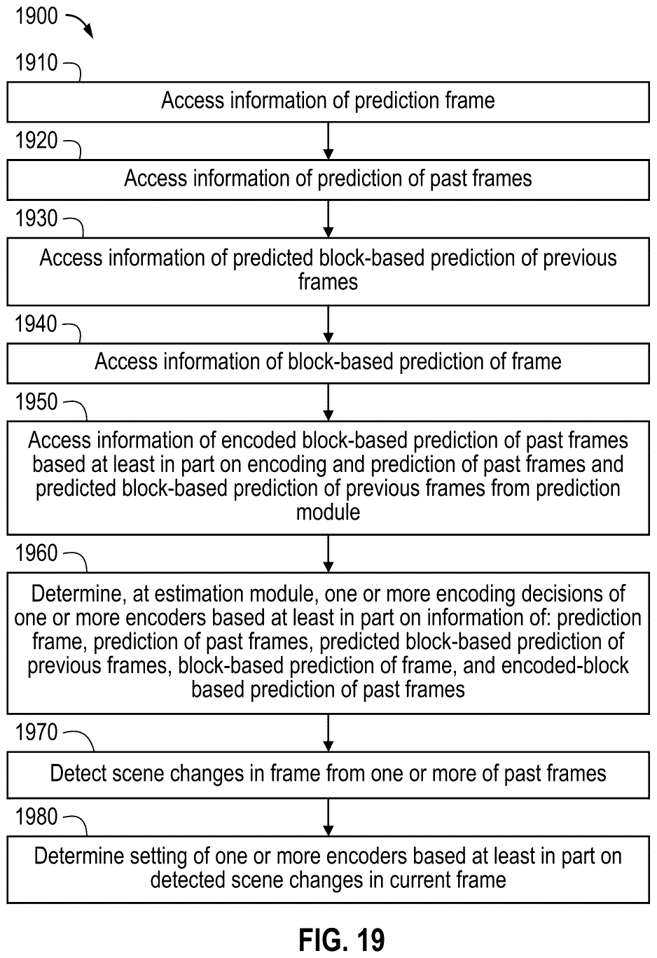

FIG. 19 is a flowchart of a method 1900 for feedback-enhanced prediction and scene change detection. For example, the method 1900 comprises at least one of: accessing 1910 information of a prediction frame (P(t)), wherein (n=t−d) with (d=1, . . . , N); accessing 1920 information of a prediction of past frames (P(n)); accessing 1930 information of predicted block-based prediction of previous frames (Pb(n)); accessing 1940 information of a block-based prediction of a frame (Pb(t)); accessing 1950 information of encoded block-based prediction of past frames (B(n)) based at least in part on encoding and prediction of past frames (P(n)) and the predicted block-based prediction of previous frames (Pb(n)) from a prediction module; determining 1960, at an estimation module, one or more encoding decisions of one or more encoders based at least in part on the information of: the prediction frame (P(t)), the prediction of past frames (P(n)), the predicted block-based prediction of previous frames (Pb(n)), the block-based prediction of the frame (Pb(t)), and the encoded block-based prediction of past frames (B(n)); detecting 1970 scene changes in the frame (F(t)) from a past frame; determining 1980 a setting of the one or more encoders based at least in part on the detected scene changes in the frame (F(t)); combinations of the same; or the like. Also, for example, the method 1900 comprises constructing input and output of the prediction module and the estimation module for training and inference of one or more neural network models for video compression. Further, for example, the one or more neural network models are trained using historical video compression data. In addition, for example, the method 1900 comprises generating the predicted block-based prediction of previous frames (Pb(n)) using motion estimation techniques. Moreover, for example, the motion estimation techniques comprise block matching algorithms. Furthermore, for example, the method 1900 comprises generating the information of the encoded block-based prediction (B(n)) based at least in part on previously encoded frames. Additionally, for example, the method 1900 comprises refining the prediction module based at least in part on the feedback based at least in part on the encoded block-based prediction (B(n)). Still further, for example, the method 1900 comprises dynamically adjusting settings of the one or more encoders based at least in part on the one or more encoding decisions made by the estimation module. Even further, for example, the detecting the scene changes in the frame (F(t)) comprises triggering a refresh of the settings of the estimation module and the one or more encoders. Yet further, for example, the method 1900 comprises maintaining consistency in residues through motion estimation across consecutive frames when no scene change is detected.

In some embodiments, either alone or in combination with one or more features of the methods and systems disclosed herein, features, methods, and systems are provided to overcome numerous technical challenges, such as a problem associated with a large size of Intra pictures compared to Predicted and Bidirectional pictures (i.e., P-pictures and B-pictures), e.g., during high-motion scenes or instant scene changes, which can cause potentially problematic spikes in bandwidth requirements to get the encoded picture delivered in time. It is noted, in video compression, and as used herein, a “frame” generally refers a complete image in a video sequence. It represents a single point in time and is composed of all the scan lines (rows of pixels) that make up the image. For example, in a video with a resolution of 1920×1080, each frame consists of 1080 lines of 1920 pixels each. As used herein, a “picture” is a more general term. It can refer to either a frame or a field. For example, a field is half of a frame, containing either the odd-numbered or even-numbered scan lines. That is, in some contexts, while every frame is a picture, not every picture is a full frame. Also, Intra-coded (I-frames) are encoded independently and contain a complete image, serving as reference points for decoding other frames. Predicted frames (P-frames) store only the changes from previous I-frames or P-frames, using motion vectors to predict the current frame based on past frames, thus reducing data. Bidirectional predicted frames (B-frames) use both previous and subsequent frames for prediction, offering the highest compression efficiency with data from surrounding frames. The terms I-pictures, P-pictures, and B-pictures are often used interchangeably with I-frames, P-frames, and B-frames, with “picture” referring to either a full frame or a field in interlaced video. That is, I-frames provide complete images, P-frames encode changes from previous frames, and B-frames use both past and future frames for maximum compression efficiency. It is noted that P-pictures can be larger than I-pictures at a scene change as demonstrated herein. Ultimately, at a scene change, any I-picture, P-picture, or B-picture can be relatively large. Also, for example, at a scene change, if an I-frame is required, encoding the I-frame to a P-frame may result in a relatively large size.

As used herein, for example, “complexity” may refer to at least one of the complexity of a picture or frame, a portion of the picture or frame, a derivative of the picture or frame, a calculation (e.g., residue, or the like) related to one or more pictures or frames, the computational effort required for encoding or decoding processes, the variability in motion or texture within a frame, the algorithmic intricacy involved in compression techniques, combinations of the same, or the like. Also, for example, differences (e.g., amounts of differences) from one picture to the next results in an encoding complexity or encoding difficulty. That is, relatively easy encodings differ little from one picture to the next; whereas, relatively difficult encodings have major differences from one picture to the next. Further, for example, in the context of video encoding, various types of calculations are performed to compress and encode video data efficiently. These include at least one of motion estimation, motion compensation, transform coding, quantization, entropy coding, rate control, intra-frame prediction, inter-frame prediction, deblocking filtering, residual calculation, complexity estimation, combinations of the same, or the like.

In a non-limiting example, in a 4K 60 Hz AVC encoded video, a scene change can result in a Predicted picture size of around 600 KB, necessitating a bandwidth spike to approximately 288 Mbps to deliver within 16.67 milliseconds (ms). This is problematic in low-latency scenarios with minimal buffering. The architecture of a video encoder includes components like intra and inter prediction, mode selector, transformation and quantization, and entropy coding (e.g., context-adaptive variable-length coding (CAVLC)). The rate controller controls bitrate and quality by dynamically adjusting encoding parameters based on complexity estimation, bit allocation models, and buffer status. However, maintaining a consistent bitrate is challenging with prior approaches due to the unpredictable nature of video content and the requirement for real-time adjustments. The rate-quantization model describes the relationship between the QP, actual bitrate, and encoding complexity, but QP only affects the detail in transformed residuals, not overhead or motion vectors. Complexity estimation using the mean average difference (MAD) of prediction error may be provided but may be challenging, e.g., especially at scene changes. The QP-limiter helps stabilize quality by limiting QP changes between frames. The virtual buffer model simulates the decoder buffer to manage bitrate variations, requiring careful management of buffer capacity and fullness. For example, initializing QP based on demanded bits per pixel is configured to set an appropriate quality level from the start. GOP bit allocation and basic unit bit allocation are used to manage bitrate across groups of pictures and smaller units within frames. As developed by some of the present inventors, for example, very large pictures and dropped packets are controlled by generating I-frames and using slicing or tiling to distribute the load over multiple frame slots; whereas, for example, rate controllers with prior approaches struggled to maintain required picture sizes for low buffer models, leading to poor quality or oversized frames, necessitating further measures to repair the stream.

In some embodiments, the following approaches are incorporated and/or improvements are made to one or more of the approaches described as follows for video encoding and prediction. For example, at least one of Advanced Video Coding (AVC) or Moving Picture Experts Group (MPEG)-4 Part 10 (i.e., H.264), MPEG-2 standards, advanced neural network models like CrevNet and ML-ResNet, are incorporated and/or improved in terms of latency, complexity, overfitting, and implementation requirements.

For example, improvements are made to encoders for video encoding rate control in accordance with the AVC or H.264 and MPEG-2 standards, adjusting parameters like quantization and bitrate. Also, for example, the present methods and systems are provided for any encoder, e.g., AVC, High Efficiency Video Coding (HEVC), Versatile Video Coding (VVC), VP9, AV1, or the like.

For example, improvements are made to Self-Clocked Rate Adaptation for Multimedia (SCREAM), which aims for low latency and high throughput in interactive video services using a hybrid congestion control algorithm. SCREAM includes frequent feedback and handling of clock drift. It is noted that a system like SCREAM sets an encoding bitrate based on an estimated bandwidth. This would be a bandwidth set on the encoder's rate controller. In some embodiments, a low-latency rate controller is provided, which selects a picture that is encoded with a QP value, which is the best encoded picture that can be delivered in time based on a given bitrate at that point in time. That is, in some embodiments, an enhancement is made in a system such as SCREAM. That said, the various embodiments presented herein are not limited to a system like SCREAM.

For example, improvements are provided to Web Real-Time Communication (WebRTC), which provides real-time communication in web applications. WebRTC supports video, voice, and data.

As provided in detail herein, for example, improvements are made to conditional variational autoencoders (CVAEs), which generate data conditioned on attributes. Also, for example, as provided in detail herein, improvements are made to variational autoencoders (VAEs), which include probabilistic modeling and KL divergence. Further, for example, improvements are made to feedforward neural networks (FNNs), which are effective in pattern recognition and classification. In addition, for example, improvements are made to CrevNet, which uses a reversible network for video prediction and integrates 3D convolutions. Moreover, for example, improvements are made to SimVP, which is a simple convolutional neural network (CNN)-based model for video prediction, which avoids complex modules and reduces training costs. Furthermore, for example, improvements are made to ExtDM, which predicts video frames by extrapolating motion cues, balances efficiency and accuracy, and utilizes a layered distribution adaptor and motion autoencoder. Additionally, for example, improvements are made to ML-ResNet, which addresses missing target labels in facial keypoint detection using a masked loss function, improves training efficiency, and is robust.

To overcome problems associated with prior approaches, in some embodiments, a video encoder rate controller is provided. For example, the video encoder rate controller is provided in an encoding system that can instantiate and/or take down frame synchronized parallel encoders. Also, for example, the encoding system allows the rate controller to provide a range of initial QP values to each encoder. Further, for example, a number of encoders may be directly related to at least one of a complexity, an amount of motion from frame to frame or picture to picture over a look-back period, a degree of a change of a position of an object, an appearance between consecutive frames, combinations of the same, or the like. In addition, for example, the initial QP values given to each encoder are based on a complexity estimation system and a virtual buffer model size. Moreover, for example, the rate controller calculates a size of each encoded frame and chooses which frame to deliver (e.g., to a client device). Furthermore, for example, the video encoder rate controller and encoding system allow an absolute best possible picture to be delivered (e.g., to the client device) running in an absolute lowest possible latency. Additionally, for example, a buffer model size for the rate controller is controlled through an API allowing an external system to adjust the virtual buffer model based on changing latency requirements.

In some embodiments, either alone or in combination with one or more features of the methods and systems disclosed herein, as noted in U.S. patent application Ser. No. 18/999,193, titled, “ULTRA-LOW-LATENCY VIDEO ENCODER AND RATE CONTROLLER,” filed Dec. 23, 2024, and concurrently with the present application (inventors Christopher Phillips, Tao Chen, and Mareeta Mathai), hereinafter “Phillips et al.,” and in U.S. patent application Ser. No. 18/999,203, titled, “MACHINE LEARNING FOR ULTRA-LOW-LATENCY VIDEO ENCODER AND RATE CONTROLLER,” also filed Dec. 23, 2024, concurrently with the present application (inventors Mareeta Mathai, Christopher Phillips, and Tao Chen), hereinafter “Mathai et al.,” a multi-encoder framework is provided to improve video compression for ultra-low-latency streaming.

For example, as set forth in Phillips et al., and Mathai et al., in some embodiments, methods and systems for controlling video encoding in an encoding system for delivering content (e.g., to a client device) comprise several steps. For example, one or more frame-synced parallel encoders are instantiated based at least in part on the complexity of a picture, a portion of the picture, or a residue of the picture, and the amount of motion from picture to picture over a look-back period. Additionally, a range of initial QP values is provided to the instantiated frame-synced parallel encoders. Further, each picture is encoded by the instantiated frame-synced parallel encoders into an encoded picture. Moreover, the size of each encoded picture is calculated. Based at least in part on the size of each encoded picture, one encoded picture is selected. Furthermore, the selected encoded picture is delivered.

The methods and systems also include selecting which encoded picture to deliver based at least in part on the highest available picture quality and the lowest available latency of the picture encoding or a derivative of the speed of delivery of the encoded picture.

Initial QP values are determined based at least in part on a complexity estimation system and the size of a virtual buffer model. Additionally, the size of the virtual buffer model is controlled through an application programming interface (API) and adjusted based at least in part on changing latency requirements. The API is configured with predefined latency thresholds, and the size of the virtual buffer model is controlled based on these thresholds.

The size of the virtual buffer model is dynamically adjusted based on real-time feedback from the client device. The number of instantiated frame-synced parallel encoders is directly proportional to the determined complexity and the amount of motion from picture to picture.

The methods and systems further include monitoring encoding performance and adjusting the initial QP values to optimize encoding performance. A rate controller in the encoding system prioritizes pictures for delivery to maintain the highest possible picture quality at the lowest available latency. The rate controller also predicts and controls future encoding requirements based on historical data of picture sizes. Additionally, the rate controller switches between different encoding profiles based on the complexity and the amount of motion from picture to picture.

In some embodiments, methods and systems for ultra-low-latency encoding and delivering video data (e.g., to a client device) comprise several steps. For example, encoding parameters, a number of encoders, a client device decoder buffer size, and a demanded capped bitrate value are received. Additionally, one or more of a plurality of encoder instances are instantiated based at least in part on the number of encoders. Further, a respective bitrate value is assigned to each encoder instance, where the bitrate value is distributed between an absolute minimum bitrate value and the demanded capped bitrate value. Moreover, video data is encoded using the instantiated encoder instances, each having the assigned respective bitrate value, to generate encoded pictures. Furthermore, an optimal encoded picture is selected from the encoded pictures based at least in part on the client device decoder buffer size and the demanded capped bitrate value. Additionally, the optimal encoded picture is transmitted.

The encoding setting parameters may include resolution, framerate, and group of pictures (GOP) structure. Further, the number of encoder instances can be dynamically updated through an API or user interface. The bitrate value assigned to each encoder instance is calculated by dividing the difference between the demanded capped bitrate value and the absolute minimum bitrate value by the number of encoder instances minus one. Additionally, the state of each encoded picture from each encoder instance is sent to an encoded picture selector.

The optimal encoded picture is selected based at least in part on the size of the picture, framerate, buffer model, or allocated bandwidth. Further, the buffer model and picture QP values of each encoder instance are adjusted based at least in part on the state of a coded picture buffer of the client device. An ultra-low-latency delivery system transmits the optimal encoded picture via the internet. Also, additional encoder instances can be instantiated from an encoder instance pool during an encoder session. The decoded pictures are stored and/or updated in a common decoded picture buffer shared by the encoder instances.

In some embodiments, methods and systems for encoding video for delivery (e.g., to a client device) using an encoder system comprise several steps. For example, uncompressed video and encoding parameters including a desired number of encoder instances are received. Additionally, a plurality of encoder instances is initialized based at least in part on the desired number of encoder instances. Further, an initial QP value is set based at least in part on a desired and/or maximum bitrate value. Moreover, the video is encoded using the plurality of encoder instances, with each encoder instance generating encoded video pictures. Furthermore, an encoded video picture is selected from the plurality of encoded video pictures based at least in part on a comparison of the encoded video picture size to a required bitrate value for the video picture. Additionally, the selected encoded video picture is transmitted.

The methods and systems also comprise receiving a picture buffer size of a decoder of the client device and adjusting the encoding based at least in part on the picture buffer size. The initial QP value is set by a QP initializer and adjusted by a AQP-limiter. The plurality of encoder instances comprises a first encoder instance and an n-th encoder instance, each configured to receive a QP value with an offset. Further, the uncompressed video is preprocessed before the encoding.

The selection of the encoded video picture is performed by an encoded picture selection function based at least in part on the size of the encoded video picture being closest to the required bitrate value without exceeding the required bitrate value. Additionally, a state of the encoder for the selected encoded video picture is transmitted back to each encoder instance to maintain synchronization. An ultra-low-latency delivery system is configured to set a capped bitrate value based at least in part on an estimated amount of bandwidth. The number of encoder instances is dynamically adjusted based at least in part on feedback regarding the desired maximum latency. The encoding parameters may include resolution, framerate, and GOP structure.

In some embodiments, methods and systems for controlling video encoding latency in a video encoding system for delivering content (e.g., to a client device) comprise several steps. For example, a latency request is received from an external system. Additionally, a required size of a buffer is determined based at least in part on the latency request. Further, a buffer size of a modeled buffer in the video encoding system is adjusted. Moreover, video encoding and video source rendering are paused to allow the buffer to drain or fill to the required buffer size. Furthermore, video encoding and video source rendering are resumed once the buffer has reached the required size. Additionally, encoded video data is transmitted.

The latency request may be received from a video game engine as the external system. Also, the latency request may be received from a simultaneous localization and mapping (SLAM) camera system as the external system. Further, a request to pause and/or resume video rendering is transmitted to a video source. Moreover, a flush buffer request is transmitted to the modeled buffer.

The video encoding system may comprise multiple encoders, and additional encoders are instantiated based at least in part on the latency request. Further, a deep learning model is used to predict an optimal number of encoder instances based at least in part on the complexity of a picture to be encoded, a portion of the picture, or a residue of the picture. Additionally, a deep learning model is used to determine a QP range for each encoder.

The adjustment of the buffer size may comprise rendering black frames or a still image to fill the buffer. Further, a forced instantaneous decoder refresh (IDR) request is transmitted to all encoders to decode the next picture without dependency on flushed encoded pictures.

In some embodiments, methods and systems for optimizing video encoding in a multi-encoder system comprise several steps. For example, a deep learning-based computer vision model determines an optimal number of encoder instances based at least in part on the complexity of a picture to be encoded, a portion of the picture, or a residue of the picture. Additionally, a QP range required for the encoder instances is determined. Further, QP values for a rate controller are set across each of the instantiated encoders based at least in part on the determined QP range.

The deep learning-based computer vision model may comprise a hybrid model configured to predict the optimal number of encoder instances by processing a residual picture of a current timestamp using an unsupervised conditional neural network. The unsupervised conditional neural network is configured to accept conditional parameters comprising encoder settings and video genre, and provide an estimate of the complexity in a latent space. A supervised model predicts the optimal number of encoder instances based at least in part on the learned latent representations from the unsupervised conditional neural network.

The deep learning-based computer vision model is configured to predict an optimal distribution of QPs among the encoder instances. The model is trained using a supervised model that accepts a predicted number of encoder instances and an initial QP as input features. The supervised model outputs the QP value for each encoder instance.

Methods and systems also include a system for long-term video prediction to output predicted pictures and residual pictures. The system for long-term video prediction comprises a video prediction module and a residual latent learning module. The video prediction module comprises a deep learning-based long-term prediction model configured to predict P-frames in a GOP and cache the predicted P-frames in a buffer.

A decision to choose or skip an encoder instance is based at least in part on a mean squared error (MSE) of the predicted P-frames. The buffer is reset if the MSE of a current predicted picture exceeds a threshold.

In some embodiments, methods and systems for training an encoder instances prediction model comprise several steps. For example, model training is initiated by setting up a model training environment, loading a dataset, initializing model parameters, and configuring a training process. Additionally, a residual picture is processed to capture motion and identify changes over time. Further, conditional parameters comprising bandwidth, resolution, and frames per second are set. Moreover, input data is encoded based at least in part on the conditional parameters into a latent space. Furthermore, the encoded data is processed through a fully connected layer to learn complex patterns and relationships. Additionally, a number of encoder instances required is determined based at least in part on the complexity of the residual picture. The data is then reconstructed from the latent space representation using a decoder. Finally, the model training is finalized by saving the trained model and preparing the trained model for deployment or further evaluation.

The residual picture is a difference between consecutive pictures in a sequence. The conditional parameters configure the model to specific conditions and requirements to ensure optimal performance under varying scenarios. The latent space is a lower-dimensional representation of the data that captures selected features of the data. The fully connected layer applies a series of transformations to the data from the latent space. The number of encoder instances is estimated based at least in part on the complexity of each video picture, or a portion of each video picture. The decoder transforms lower-dimensional data back into the original form or a desired output format.

Methods and systems also comprise training the model using a combined loss function that comprises reconstruction loss and Kullback-Leibler (KL)-Divergence loss. The reconstruction loss measures the ability of the model to reconstruct the input data. The KL-Divergence loss regularizes the latent space by ensuring the encoded latent space distribution is close to a normal distribution.

In some embodiments, methods and systems for encoding video using a multiple encoder system comprise several steps. For example, uncompressed video pictures are received from a video source. Additionally, the uncompressed video pictures are processed into selected encoded picture bits to be sent (e.g., to a client device.). Further, a residual picture is fed to a pretrained variational autoencoder (VAE) to predict a number of encoder instances. Moreover, a pretrained QP distribution prediction model is used to predict QP for each encoder instance. Furthermore, a number of encoders are instantiated based at least in part on the predicted number of encoder instances. Additionally, the predicted QPs are distributed to the instantiated encoders. The uncompressed video pictures are then encoded using the instantiated encoders and the distributed QPs. Encoded pictures are selected from the encoded outputs of the instantiated encoders. The selected encoded picture bits are transmitted. The QPs are adjusted based at least in part on feedback from a virtual buffer model and conditional parameters.

The video source may be a game engine. The pretrained VAE receives conditional parameters comprising bandwidth, genre of a game of the game engine, resolution, and frames per second. The pretrained QP distribution prediction model is fine-tuned based at least in part on feedback from an encoded picture selection module. The virtual buffer model communicates buffer size and buffer fullness to the pretrained VAE and a rate controller of the multiple encoder system. The rate controller adjusts an initial QP based at least in part on the buffer fullness.

Methods and systems also comprise generating future pictures at a deep learning-based long-term prediction module based at least in part on past pictures. The deep learning-based long-term prediction module may comprise a conditionally reversible architecture, a simple video prediction architecture, or a distribution extrapolation diffusion model architecture. The deep learning-based long-term prediction module is trained based at least in part on a MSE loss between predicted and actual pictures. A decision to instantiate encoder instances is based at least in part on the MSE of the predicted pictures.

In some embodiments, methods and systems for training a long-term prediction module comprise several steps. For example, model training is initiated by setting up a training environment, loading a dataset, initializing model parameters, and configuring the training process. Additionally, past reference pictures are received to capture temporal dependencies for long-term video prediction. Further, predicted pictures representing anticipated future states of the video are generated based at least in part on the past reference pictures. Moreover, original pictures are received for comparison with the predicted pictures. Furthermore, differences between the original pictures and the predicted pictures are calculated to identify residual pictures. Additionally, predictions of the model are refined based at least in part on the residual picture. Conditional parameters comprising bandwidth, resolution, and frames per second are received. Input data is encoded based at least in part on the conditional parameters. The encoded data is mapped into a latent space. The data from the latent space is processed through a fully connected layer to learn complex patterns. A number of encoder instances is determined. The data is reconstructed from the latent space representation through a decoder. Finally, the model training is finalized by saving the trained model and preparing the trained model for deployment.

The initiating model training further comprises configuring hyperparameters for the prediction model. The receiving past reference pictures comprises preprocessing the pictures to enhance temporal feature extraction. The generating predicted pictures comprises a recurrent neural network (RNN). The receiving original pictures comprises synchronizing the original pictures with the predicted pictures for accurate comparison. The calculating differences comprises an MSE metric to quantify residual pictures. The refining the prediction of the model comprises iterative training to minimize the residual pictures. The conditional parameters are normalized before the encoding. The mapping into a latent space uses a VAE for dimensionality reduction. The reconstructing data comprises applying a deconvolutional neural network (DCNN) for data reconstruction.

In some embodiments, methods and systems for testing a long-term prediction module comprise several steps. For example, a testing environment is initialized. Additionally, downsampled reference video pictures from previous timestamps are received. Further, future video pictures are predicted using a pretrained long-term video prediction model. Moreover, predicted future video pictures are generated. Furthermore, the predicted future video pictures are stored in a buffer. Additionally, an actual downsampled picture for a current timestamp is obtained. An MSE between the predicted picture and the actual picture is calculated. Whether the MSE is greater than or equal to a threshold is determined. The current configuration is maintained if the MSE is within acceptable limits. A residual picture representing the difference between the predicted picture and the actual picture is calculated. The residual picture is processed using a pretrained autoencoder. An entropy of a latent space representation of the residual picture is calculated. A complexity score based at least in part on the entropy is generated. A QP range based at least in part on the complexity score is estimated. The testing process is finalized.

The initializing of the testing environment further comprises setting up configurations and loading the pretrained long-term video prediction model and the pretrained autoencoder. The receiving of downsampled reference video pictures comprises obtaining pictures from time stamps F(t−x) to F(t−1). The predicting of future pictures with the pretrained long-term video prediction model comprises forecasting future pictures based at least in part on learned temporal patterns. The generating of predicted future video pictures comprises generating pictures for time stamps F(t) to F(t+n). The storing of the predicted future video pictures in the buffer comprises preparing the pictures for further processing. The calculating of the MSE comprises comparing the predicted picture at the current time stamp with the actual downsampled picture. The determining of whether the MSE is greater than or equal to the threshold comprises evaluating the accuracy of the prediction. The maintaining of the current configuration comprises continuing with the previous number of encoder instances and QP range if the MSE is within acceptable limits. The finalizing of the testing process comprises saving the results and preparing the results for further evaluation or deployment.

Related devices, systems, non-transitory computer-readable media, and the like are provided for ultra-low-latency content delivery, processing, and/or rendering.

In some embodiments, either alone or in combination with one or more features of the methods and systems disclosed herein, in the examples of FIGS. 5 and 6 herein, an architecture of a video encoder and rate controller is provided, which controls bitrate and quality by dynamically adjusting encoding parameters. Also, for example, complexity estimation using the Mean Absolute Difference (MAD) of prediction errors is provided to reflect encoding complexity. The rate controller includes a AQP-limiter to stabilize quality, a virtual buffer model to smooth data rate variations, and a QP initializer to set initial quality parameters. The rate controller dynamically adjusts the QP based on the complexity and buffer status to maintain consistent video quality and bitrate. It also addresses scene changes by generating I-frames and using slicing or tiling to manage large frames and ensure timely delivery in low-latency environments. According to some embodiments, FIG. 5 depicts an architecture of a video encoder 500 (e.g., 655, 670) for the system 600 of FIG. 6, in accordance with some embodiments of the disclosure. FIG. 6 depicts an architecture of a rate controller 600 within the video encoder 500 of FIG. 5, in accordance with some embodiments of the disclosure.

In some embodiments, the encoder 500 encodes a video at a set QP. The QP is an index that controls an amount of compression for each macroblock in a frame in an encoder. Larger values of QP mean higher quantization, more compression, and lower quality, while smaller values mean the opposite. For AVC and HEVC, the QP values range, for example, from 0 to 51, and any value above 51 is clamped to 51. Also, for example, VVC increases the QP values from 0 to 63. When an encoder is set to encode at a fixed QP value, the size of each picture can vary widely based on the motion-compensated difference from one picture to the next. The same goes for the size of the slices or tiles.

In some embodiments, the encoder 500 includes at least one of a current video frame (f(n)) 510, a reference video frame (f(n−1)) 520, a reconstructed video frame (f(n)) 530, an intra prediction module 540, an inter prediction module 550, a mode selector 560, a transformation and quantization module 570, an inverse transformation and quantization module 580, a CAVLC module 590 that outputs an encoded stream, combinations of the same, or the like. For example, a video encoding process with the encoder 500 starts with the current video frame (f(n)) 510 and the reference video frame (f(n−1)) 520. The current video frame 510 is the one being encoded, while the reference video frame 520 is typically a previously encoded frame. The intra prediction module 540 and the inter prediction module 550 work together to predict the current frame based on the reference frame. Intra prediction works within the same frame, predicting parts of the image based on other parts within the same frame. Inter prediction, on the other hand, predicts the current frame based on data from the reference frame. The mode selector 560 then decides whether to use intra or inter prediction for each block of pixels in the frame, based on, for example, which method provides the best compression. The selected prediction is then subtracted from the original frame to create a residual frame, which is passed to the transformation and quantization module 570. This module transforms the residual frame into the frequency domain and quantizes it, reducing the precision of the data to save space. The quantized data is then passed to the inverse transformation and quantization module 580, which reverses the previous step, creating a reconstructed video frame (f(n)) 530. This frame 530 is used as the reference frame for the next frame to be encoded. Finally, the quantized data is encoded into a bitstream by, e.g., the CAVLC module 590. The module 590 uses variable-length codes, which assign shorter codes to more common patterns of data, further compressing the video. The output is an encoded stream that can be efficiently transmitted or stored. The process associated with the encoder 500 provides high-quality video at low bitrates.

To control the bitrate or encode to a fixed constant bitrate or a capped variable bitrate, the encoding system has a component called a rate controller. The rate controller is configured to balance the bitrate and quality of the compressed video. The rate controller dynamically adjusts encoding parameters based on complexity estimation, bit allocation models, and buffer status to achieve efficient and consistent video compression.

An architecture for a rate controller in a video encoding system is provided. For example, as shown on the right side of the FIG. 6, a video encoder (e.g., 655, 670) is shown. This is an encoder as depicted in FIG. 5 (e.g., encoder 500). An exemplary embodiment of the architecture is detailed below. The encoder receives the uncompressed source video. The encoder receives a QP from the rate controller. The rate controller also receives a complexity estimate calculated based on the source video. The rate controller receives a demanded bitrate or max capped bitrate received from a user's user interface (UI) setting or through an API setting from a system such as SCREAM. The rate controller controls the bitrate within the requested demanded bitrate. The output of the compressed video will average out to be in line with the demanded bitrate. This comes with a major challenge as mentioned herein. This can be explained in looking at the left side (detailed) architecture of the rate controller.

In some embodiments, a rate controller includes at least one of an encoder interface, a rate-quantization model, a complexity estimator, a AQP-limiter, a virtual buffer model, a QP initializer, a GOP bit allocator, a basic unit bit allocator, combinations of the same, or the like. For example, one or more encoder interfaces are provided. Also, for example, the encoder interface includes inputs and/or outputs such as basic unit residuals, residual bits, and total bits. Further, for example, the AQP-limiter outputs a target QP to the encoder, which is dynamically changing to keep the encoder within the demanded bitrate within the timeframe of the buffer model.

For example, a rate-quantization model is provided. Also, for example, the rate-quantization model defines a relationship between QP, actual bitrate, and a surrogate for encoding complexity. However, in some embodiments, the bits and complexity terms are associated only with the residuals. Further, for example, the QP influences the detail of information carried in the transformed residuals. In addition, for example, QP has no direct effect on the bitrates associated with overhead, prediction data, or motion vectors. Moreover, for example, a MAD of the prediction error is used. Furthermore, for example, the rate-quantization model takes an algebraic form such as equation (1), as follows:

$$ResidualBits = C 1 * MAD / QP + C 2 * MAD / QP \hat{} 2 \qquad ( 1 )$$

where C1 and C2 are constants.

Additionally, for example, the rate-quantization model takes a simpler form (e.g., with C2=0). Still further, for example, the rate-quantization model takes a more complicated form involving exponentials or other basis curves for fitting. Even further, for example, the rate-quantization model is solved for a demanded QP when a target value of ResidualBits is supplied by bit allocation.

For example, complexity estimation is provided. Also, for example, a metric is provided reflecting encoding complexity associated with residuals. Further, for example, a MAD of a prediction error is provided to reflect encoding complexity associated with residuals. In addition, for example, the MAD of the prediction error may be provided in accordance with equation (2), as follows:

$$MAD = {\sum }_{i , j} \vert residual ( i , j ) \vert = {\sum }_{i , j} \vert source ( i , j ) - prediction ( i , j ) \vert \qquad ( 2 )$$

where the sum of the absolute differences is calculated between the source values and the predicted values over all pixels ((i,j)). The residual is the difference between the source and the prediction at each pixel.

The MAD is an inverse measure of an accuracy of a predictor and (in the case of inter-prediction) the temporal similarity of adjacent pictures.

Moreover, for example, the MAD is estimated after encoding the current picture. Furthermore, for example, estimating the MAD after encoding the current picture requires encoding the picture again after the QP is selected. It is noted that such encoding of the picture again after the QP is selected is, without embodiments disclosed herein, a burden for a computationally intensive standard like H.264, H.265, or H.266 at high framerates and resolutions. Instead, in accordance with embodiments disclosed herein, for example, a complexity surrogate varies gradually from picture to picture. Additionally, for example, the complexity surrogate is estimated based upon data extracted from the encoder for previous pictures. Still further, for example, utilizing other approaches, estimating the complexity surrogate based upon the data extracted from the encoder for the previous pictures may, without utilizing one or more of the embodiments disclosed herein, fail at a scene change.

For example, a AQP-limiter is provided. Also, for example, a closed loop control system is damped to guarantee stability and to minimize perceptible variations in quality. Further, for example, for difficult sequences having rapid changes in complexity, QP-demand may oscillate noticeably. In order to control such difficult sequences having rapid changes in complexity, for example, a rate limiter is provided, which limits changes in QP to no more than, e.g., +2 units between pictures.

For example, a virtual buffer model is provided. Also, for example, a compliant decoder is equipped with a buffer to smooth out variations in the rate and arrival time of incoming data. Further, for example, the corresponding encoder produces a bitstream that satisfies constraints of the decoder, so a virtual buffer model is used to simulate the fullness of the real decoder buffer. In addition, for example, the change in fullness of the virtual buffer is the difference between the total bits encoded into the stream, less a constant removal rate assumed to equal the bandwidth (or demanded bitrate). Moreover, for example, the buffer fullness is bounded by zero from below and by the buffer capacity from above. Furthermore, for example, the user device specifies appropriate values for buffer capacity and initial buffer fullness, consistent with the decoder levels supported.

For example, a QP initializer is provided. Also, for example, QP is initialized upon start of a video sequence. Further, for example, an initial value is input manually. In addition, for example, an initial QP value is estimated from demanded bits per pixel, e.g., in accordance with equation (3).

$$DemandedBitsPerPixel = DemandedBitrate / ( FrameRate * height * width ) \qquad ( 3 )$$

For example, GOP bit allocation is provided. Also, for example, GOP bit allocation is based upon the demanded bitrate and the current fullness of the virtual buffer. Further, for example, a target bitrate for the entire GOP is determined, and QPs for the GOP's I-picture and first P-picture are also determined. In addition, for example, the GOP target is fed into the next block for detailed bit allocation to pictures.

For example, basic unit bit allocation is provided. Also, for example, the “basic unit” is a basis for H.264 rate control recommendations. Further, for example, scalable rate control is pursued to different levels of granularity, such as picture, slice, macroblock row or any contiguous set of macroblocks. That level is referred to as a basic unit at which rate control is resolved, and for which distinct values of QP are calculated. If the basic unit is smaller than a picture, then this block (e.g., in FIG. 6) actually breaks out into two layers: one for the picture itself and another for the basic unit. FIG. 6 is limited to the case where the picture itself is the basic unit.

For H.264, for example, the emphasis is on computing QP for each stored picture (usually a P-picture). It is noted that the H.264 standard allows B-pictures to be used as reference pictures; however, such usage is not expected to be common. Also, for example, the QPs for non-stored pictures (e.g., B-pictures) are then interpolated (e.g., and offset) from QP values for their neighboring P-pictures. First, for example, considering the MAD of the picture, a target level for the buffer fullness is determined. Then, for example, using the buffer target level, the target bits for the picture are calculated in a computationally efficient manner. Also, it is noted that B-pictures introduce additional latency. In ultra-low-latency cases, the encoder would probably not be configured for B-pictures; however, the system would still work with the added latency of the B-pictures.

In some embodiments, a rate controller 600 is provided, as shown in FIG. 6, which, for example, adjusts the QP value dynamically based on the encoded pictures and their sizes. It does this using a virtual buffer model 650 that maintains the average bitrate within scope of the set bitrate. The encoder may be set to encode at a constant bitrate or a capped virtual bitrate. In either case, the bitrate should not exceed the set bitrate. This bitrate averages out over time based on the virtual buffer model 650. The buffer models for video encoders are typically not adjustable and are fixed within the encoder. As noted herein, in some approaches, there were frames that were very large in size and many frames that were smaller in size. This variance in frames is a prime example of how the rate controller cannot make QP adjustments in time to adjust each frame size to be within the size of the encoded bitrate and will average out to the target bitrate over the course of time as modeled in the virtual buffer model 650 within the encoder's rate controller 600.

The previous description of the encoder's rate controller 600 is distinguished from the rate controller in, e.g., a real-time transport protocol (RTP) delivery system, e.g., the rate controller of the video encoding rate control and repair 660. The rate controller in the RTP delivery system controls the bitrate based on the priority queue to the encoder. This rate controller is different from the encoder's rate controller and is external to the encoder. The RTP delivery system makes API calls to change the encoder's target bitrate based on the priority queue size.

In some embodiments, the controller 600 includes at least one of an encoder interface 605, a rate controller module 615, a complexity estimation unit 620, a rate-quantization model 625, a AQP-limiter 630, a GOP bit allocation unit 635, a basic unit bit allocation unit 640, a QP initializer 645, a virtual buffer model 650, combinations of the same, or the like. Increasing source complexity refers to QP versus bitrate, where bitrate decreases as QP increases, and vice-versa, i.e., see also the QP-to-bitrate curves 610, 665. One or more portions of the controller 600 may be operatively connected with at least one of an encoder 655 and a rate controller 660, or an encoder 670.

The controller 600 includes several modules that work together to manage the quality and bitrate of the encoded video. The encoder interface 605 serves as the communication link between the controller 615 and an encoder (e.g., 655). The encoder interface 605 receives information about the video from the encoder and sends back the decisions made by the rate controller 615. The rate controller module 615 manages the overall bitrate of the video. It uses information from the complexity estimation unit 620, which measures the complexity of the video and outputs, e.g., the MAD, and the rate-quantization model 625, which models the relationship between the QP and the bitrate and outputs, e.g., QP-demand. The AQP-limiter 630 ensures that the QP does not change too rapidly from frame to frame and outputs, e.g., QP. The GOP bit allocation unit 635 and the basic unit bit allocation unit 640 work together to allocate bits to different parts of the video. The GOP unit 635 allocates bits to GOPs. For example, the GOP unit 635 receives a demanded bitrate and outputs GOP target bits. The basic unit 640 allocates bits within each picture. For example, the basic unit 640 receives the GOP target bits from the GOP unit 635 and buffer fullness from the virtual buffer model 650 and outputs target bits. The QP initializer 645 receives the demanded bitrate and sets the initial QP for each picture based on the target bitrate and the estimated complexity. The virtual buffer model 650 receives a buffer capacity and keeps track of the buffer fullness and adjusts the QP to prevent the buffer from overflowing or underflowing. The controller 600 is designed to control increasing source complexity 610, where the bitrate decreases as the QP increases. This is managed by the rate controller module 615 and the rate-quantization model 625, which adjust the QP to maintain a constant bitrate despite the increasing complexity. The controller 600 may be operatively connected with at least one of an encoder 655, which receives the uncompressed source and QP and outputs a bitrate and compressed video, and a rate controller 660 when a complexity estimate is provided to the rate controller 660 based on the uncompressed source. Once the bitrate is set, the controller 600, which is connected to an encoder 670, receives the uncompressed source and QP and outputs a bitrate and compressed video. That is, the controller 600 controls the encoding process and manages the bitrate of the video. The process for controller 600 provides high-quality video at a controlled bitrate.

In some approaches, very large pictures and dropped video packets are controlled and/or pictures that arrive too late for a viewable (e.g., timely, smooth) display are repaired. To encode the video into slices or tiles, and when a very large picture occurs or for repair of late picture arrival or dropped packets, an I-frame is generated in place of the large P-frame and delivered to client devices over the next few frame slots. Also, for example, to encode the video into slices or tiles, slicing may be performed in AVC, High Efficiency Video Coding (HEVC), or Versatile Video Coding (VVC), and tiling may be performed in HEVC and VVC. These approaches include generating an I-frame at scene change detection points, along with slicing or tiling to break the delivery of the large frame into several frame time slots, delivering a subset of the picture's slices or tiles over the course of several frame slots.

In an approach, systems and methods are provided for optimizing scene change detection and I-frame generation for improving video compression in cloud gaming and other interactive experiences. The approach highlights the challenges of quick scene changes and the requirement for low latency. The approach includes a rate controller that adjusts the QP and bitrate based on network conditions. The approach also provides frame partitioning, preventive encoding, and interactive signaling between encoder and decoder. In another approach, frame repair is achieved using slicing or tiling for dropped packets that result in a corrupt frame and late frame arrival. Both approaches include slicing and tiling to send a very large frame in slices or tiles, performing the repair over the next several frame slots, thus reducing the requirement for a very large frame to be sent (e.g., to the client device) in time when there is virtually no buffer on the client device.

For extreme and/or ultra-low-latency encoding use cases like cloud gaming, remote vehicle control, and cloud-based SLAM, an encoding system is provided, video is encoded, and the video is transported (e.g., to a client device) running with no buffer. As described herein, in accordance with some approaches, previously provided rate controller designs do a very poor job of keeping the encoded picture sizes within the required size for extremely low buffer models in a live one-pass encoding solution. For example, even in a two-pass encoding solution, which may introduce latency on scene changes or for complex video, the second pass may still not provide optimum results and may miscalculate the next QP prediction, resulting in a frame of poor quality due to picking a QP value that is too high, or worse, estimating a next QP value that is too low, resulting in a frame that is still too large, necessitating other measures to repair the stream for it to be delivered and decoded in time.

In some embodiments, a rate controller is provided in an encoding system that is configured to instantiate and/or take down frame synchronized parallel encoders allowing the rate controller to provide a range of initial QP values that will be used to send a targeted QP value to each encoder. For example, the number of encoders may be directly related to the complexity and/or amount of motion from frame to frame over a look-back period. Further, for example, the initial QP values given to each encoder are based on the complexity estimation system and the virtual buffer model size. In addition, for example, the rate controller calculates the size of each encoded frame and chooses which frame to deliver (e.g., to the client device). Moreover, for example, the rate controller and/or the encoding system allows a highest-quality picture to be delivered (e.g., to the client device) within the available bandwidth to deliver content to the client device in a set amount of time. Furthermore, for example, a buffer model size for the rate controller is controlled through an API allowing an external system to adjust the virtual buffer model based on changing latency requirements.

In some embodiments, an AI system 2000 comprises a predictive model and/or predictive engine. For example, the predictive model/engine is modeled, trained, and utilized to predict information for one or more portions of the above-described methods and systems. Also, for example, the AI system 2000 dynamically adjusts the bitrate of the video stream by predicting network conditions and user device capabilities in real-time. By analyzing metadata and load data, it ensures smooth playback without buffering, even when network conditions vary. Further, for example, the AI system 2000 detects certain scene changes (e.g., complex, involving numerous changes, or the like) in incoming video frames. When a scene change is detected, the system adjusts encoding parameters to optimize compression for the new scene, maintaining high video quality while minimizing data usage. In addition, for example, by predicting future states of the network and user devices, the AI system 2000 allocates encoding resources more efficiently. For example, during peak usage times, the AI system 2000 preemptively allocates more resources to high-demand areas, ensuring consistent video quality for all users. Moreover, for example, an AI model of the AI system 2000 enhances motion prediction by learning from historical data. The AI model identifies patterns in motion vectors and residuals, allowing for more accurate predictions and better compression efficiency. This reduces the amount of data to encode motion, leading to faster processing and lower latency. Furthermore, for example, the AI system 2000 analyzes user behavior patterns, such as viewing habits and preferences. The user behavior patterns are used to pre-fetch and pre-encode popular content, reducing wait times for users and ensuring a seamless viewing experience. Additionally, for example, the AI model of the AI system 2000 incorporates real-time feedback from user devices to continuously refine encoding parameters. If a user experiences buffering or quality drops, the AI system 2000 immediately adjusts the encoding settings to address the issue and improve the viewing experience. Still further, for example, the AI system 2000 develops adaptive encoding strategies based on the type of content being streamed. For example, fast-moving sports content may require different encoding settings compared to a slow-paced documentary. The AI system 2000 automatically adjusts settings to optimize compression for each type of content. Even further, for example, by predicting the computational load and adjusting encoding processes accordingly, the AI system 2000 optimizes energy consumption, which is a consideration for mobile devices, where battery life is a determinative factor. Efficient encoding reduces the processing power required, extending battery life. Yet further, for example, the AI system 2000 integrates AI with video compression techniques to improve video quality and reduce latency. Further still, for example, the AI system 2000 analyzes and predicts various factors in real-time for more efficient video processing.

Throughout the present disclosure, in some embodiments, determinations, predictions, likelihoods, and the like are determined with one or more predictive models. In some embodiments, the model receives various forms of data about users, media content items, devices, servers, and more. This includes usage data, load-balancing data, and metadata. The model performs analysis based on hard rules, learning rules, hard models, learning models, usage data, load data, analytics, metadata, profile information, or combinations of these. The model outputs predictions of a future state of any of the devices described. Load-increasing events are determined by load-balancing processes. The model is based on inputs including hard rules, user-defined rules, rules defined by content providers, hard models, learning models, or combinations of these. The model is trained with data using various data processes, analytical processes, and machine learning approaches. It includes regression and classification analyses. An example of a multi-layer neural network is provided. The model is based on data engineering and modeling processes, and is operationalized using registration, deployment, monitoring, and retraining processes. The model is configured to output results to one or multiple devices, which can perform various functions. The devices can be a server, tablet, media display device, network-connected computer, media device, computing device, or combinations of these. The model outputs a current state, future state, determination, prediction, or likelihood. These outputs may be compared to a predetermined or determined standard. If the standard is satisfied or rejected, the predictive process outputs at least one of the current state, future state, determination, prediction, or likelihood to any device or module disclosed.

In some embodiments, the model ingests diverse forms of data about users, digital content items, devices, and more. This encompasses user interaction data, load-distribution data, and metadata. The model conducts analysis based on deterministic rules, learned rules, deterministic models, learned models, user interaction data, load data, analytics, metadata, user profile information, or combinations thereof. The model generates predictions of a future state of any of the described devices. Load-increasing events are identified by load-distribution processes.

The model is constructed based on inputs including deterministic rules, user-defined rules, rules defined by content providers, deterministic models, learned models, or combinations thereof. The model is trained with data using various data processing methods, analytical processes, and machine learning techniques. It includes regression and classification analyses. An example of a deep neural network is provided.

The model is built upon data engineering and modeling processes and is operationalized using registration, deployment, monitoring, and retraining processes. The model is designed to output results to one or multiple devices, which can perform various functions. The devices can be a server, tablet, digital display device, network-connected computer, media device, computing device, or combinations thereof.

The model outputs a current state, future state, determination, prediction, or probability. These outputs may be compared to a predetermined or determined benchmark. If the benchmark is met or not met, the predictive process outputs at least one of the current state, future state, determination, prediction, or probability to any device or module disclosed.

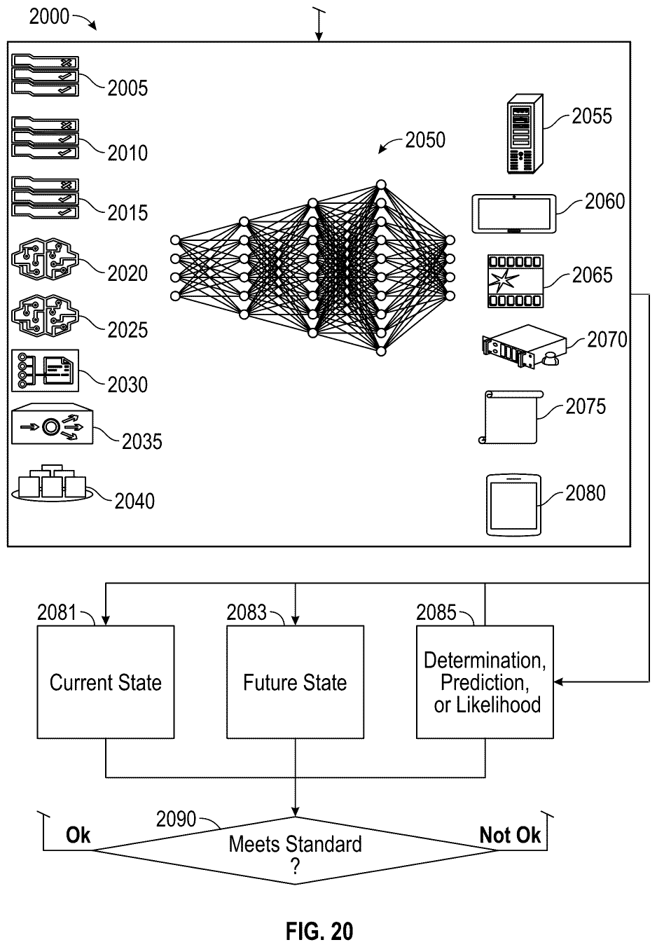

For example, FIG. 20 depicts a predictive model of an AI system 2000. The AI system 2000 includes a predictive model 2050 in some embodiments. The predictive model 2050 receives as input various forms of data about one, more or all the users, media content items, devices, servers, and data described in the present disclosure. The predictive model 2050 performs analysis based on at least one of hard rules, learning rules, hard models, learning models, usage data, load data, analytics of the same, metadata, profile information, combinations of the same, or the like. The predictive model 2050 outputs one or more predictions of a future state of any of the devices described in the present disclosure. A load-increasing event is determined by load-balancing processes, e.g., least connection, least bandwidth, round robin, server response time, weighted versions of the same, resource-based processes, and address hashing. The predictive model 2050 is based on input including at least one of a hard rule 2005, a user-defined rule 2010, a rule defined by a content provider 2015, a hard model 2020, a learning model 2025, combinations of the same, or the like.

The predictive model 2050 receives as input usage data 2030. The predictive model 2050 is based, in some embodiments, on at least one of a usage pattern of the user or media device, a usage pattern of the requesting media device, a usage pattern of the media content item, a usage pattern of the communication system or network, a usage pattern of the profile, a usage pattern of the media device, combinations of the same, or the like.

The predictive model 2050 receives as input load-balancing data 2035. The predictive model 2050 is based on at least one of load data of the display device, load data of the requesting media device, load data of the media content item, load data of the communication system or network, load data of the profile, load data of the media device, combinations of the same, or the like.

The predictive model 2050 receives as input metadata 2040. The predictive model 2050 is based on at least one of metadata of the streaming service, metadata of the requesting media device, metadata of the media content item, metadata of the communication system or network, metadata of the profile, metadata of the media device, combinations of the same, or the like. The metadata includes information of the type represented in the media device manifest.

The predictive model 2050 is trained with data. The training data is developed in some embodiments using one or more data processes including but not limited to data selection, data sourcing, and data synthesis. The predictive model 2050 is trained in some embodiments with one or more analytical processes including but not limited to classification and regression trees (CART), discrete choice models, linear regression models, logistic regression, logit versus probit, multinomial logistic regression, multivariate adaptive regression splines, probit regression, regression processes, survival or duration analysis, and time series models. The predictive model 2050 is trained in some embodiments with one or more machine learning approaches including but not limited to supervised learning, unsupervised learning, semi-supervised learning, reinforcement learning, and dimensionality reduction. The predictive model 2050 in some embodiments includes regression analysis including analysis of variance (ANOVA), linear regression, logistic regression, ridge regression, and/or time series. The predictive model 2050 in some embodiments includes classification analysis including decision trees and/or neural networks. In FIG. 20, a depiction of a multi-layer neural network is provided as a non-limiting example of a predictive model 2050, the neural network including an input layer (left side), three hidden layers (middle), and an output layer (right side) with 32 neurons and 192 edges, which is intended to be illustrative, not limiting. The predictive model 2050 is based on data engineering and/or modeling processes. The data engineering processes include exploration, cleaning, normalizing, feature engineering, and scaling. The modeling processes include model selection, training, evaluation, and tuning. The predictive model 2050 is operationalized using registration, deployment, monitoring, and/or retraining processes.

The predictive model 2040 is configured to output results to a device or multiple devices. The device includes means for performing one, more, or all the features referenced herein of the systems, methods, processes, and outputs of one or more of FIGS. 1-19, in any suitable combination. The device is at least one of a server 2055, a tablet 2060, a media display device 2065, a network-connected computer 2070, a media device 2075, a computing device 2080, combinations of the same, or the like.

The predictive model 2050 is configured to output a current state 2081, and/or a future state 2083, and/or a determination, a prediction, or a likelihood 2085, and the like. The current state 2081, and/or the future state 2083, and/or the determination, the prediction, or the likelihood 2085, and the like may be compared 2090 to a predetermined or determined standard. In some embodiments, the standard is satisfied (2090=OK) or rejected (2090=NOT OK). If the standard is satisfied or rejected, the AI system 2000 outputs at least one of the current state, the future state, the determination, the prediction, the likelihood to any device or module disclosed herein, combinations of the same, or the like. In some embodiments, the predictive model 2050 incorporates one or more LLMs.

A communication system is provided including a computing device, a server, and a communication network. Both the server and the communication network can exist in multiple forms and can connect directly or indirectly. The computing device includes control circuitry, a display, and input/output (I/O) circuitry. The control circuitry can execute systems, methods, processes, and outputs. Both the computing device and server include control circuitry and storage, which can store content, metadata, data, user profiles, messages, and commands for an application. The computing device communicates with an I/O device and can receive and process user inputs locally or transmit inputs to the remote server for processing. Both the server and the computing device can transmit and receive content via the communication network or directly, and the processing circuitry receives the user input and converts it to digital signals.

In some embodiments, the system is a distributed network architecture with an edge device (a type of computing device 2102), a cloud server (a type of server 2104), and an internet of things (IOT) network (a type of communication network 2106). Both the edge device and server have microservices and data lakes. The edge device includes a user interface and I/O ports. User interactions can be processed at the edge or in the cloud. The system can transmit and receive digital assets via the IoT network. The edge device communicates with an IoT device and can be various types of smart devices capable of displaying and interacting with digital content. The communication paths in the system can be optimized for latency and bandwidth efficiency.

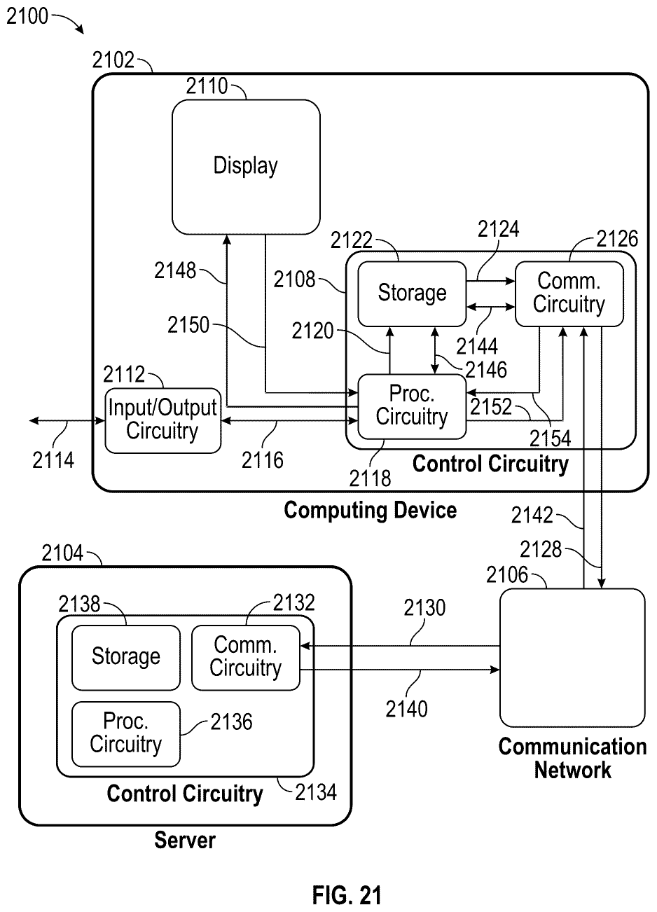

FIG. 21 depicts a block diagram of system 2100, in accordance with some embodiments. The system is shown to include computing device 2102, server 2104, and a communication network 2106. It is understood that while a single instance of a component may be shown and described relative to FIG. 21, additional embodiments of the component may be employed. For example, server 2104 may include, or may be incorporated in, more than one server. Similarly, communication network 2106 may include, or may be incorporated in, more than one communication network. Server 2104 is shown communicatively coupled to computing device 2102 through communication network 2106. While not shown in FIG. 21, server 2104 may be directly communicatively coupled to computing device 2102, for example, in a system absent or bypassing communication network 2106.

Communication network 2106 may include one or more network systems, such as, without limitation, the internet, LAN, Wi-Fi, wireless, or other network systems suitable for audio processing applications. The system 2100 of FIG. 21 excludes server 2104, and functionality that would otherwise be implemented by server 2104 is instead implemented by other components of the system depicted by FIG. 21, such as one or more components of communication network 2106. In still other embodiments, server 2104 works in conjunction with one or more components of communication network 2106 to implement certain functionality described herein in a distributed or cooperative manner. Similarly, the system depicted by FIG. 21 excludes computing device 2102, and functionality that would otherwise be implemented by computing device 2102 is instead implemented by other components of the system depicted by FIG. 21, such as one or more components of communication network 2106 or server 2104 or a combination of the same. In other embodiments, computing device 2102 works in conjunction with one or more components of communication network 2106 or server 2104 to implement certain functionality described herein in a distributed or cooperative manner.

Computing device 2102 includes control circuitry 2108, display 2110 and I/O circuitry 2112. Control circuitry 2108 may be based on any suitable processing circuitry and includes control circuits and memory circuits, which may be disposed on a single integrated circuit or may be discrete components. As referred to herein, processing circuitry should be understood to mean circuitry based on at least one microprocessors, microcontrollers, digital signal processors, programmable logic devices, field-programmable gate arrays (FPGAs), application-specific integrated circuits (ASICs), system-on-chip (SoC), application-specific standard parts (ASSPs), indium phosphide (InP)-based monolithic integration and silicon photonics, non-classical devices, organic semiconductors, compound semiconductors, “More Moore” devices, “More than Moore” devices, cloud-computing devices, combinations of the same, or the like, and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i7 processor and an Intel Core i9 processor). Some control circuits may be implemented in hardware, firmware, or software. Control circuitry 2108 in turn includes communication circuitry 2126, storage 2122 and processing circuitry 2118. Either of control circuitry 2108 and 2134 may be utilized to execute or perform any or all the systems, methods, processes, and outputs of one or more of FIGS. 1-20, or any combination of steps thereof (e.g., as enabled by processing circuitries 2118 and 2136, respectively).

In addition to control circuitry 2108 and 2134, computing device 2102 and server 2104 may each include storage (storage 2122, and storage 2138, respectively). Each of storages 2122 and 2138 may be an electronic storage device. As referred to herein, the phrase “electronic storage device” or “storage device” should be understood to mean any device for storing electronic data, computer software, or firmware, such as random-access memory, read-only memory, cloud-based storage, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 2122 and 2138 may be used to store several types of content, metadata, and/or other types of data. Non-volatile memory may also be used (e.g., to launch a boot-up routine and other instructions). Cloud-based storage may be used to supplement storages 2122 and 2138 or instead of storages 2122 and 2138. In some embodiments, a user profile and messages corresponding to a chain of communication may be stored in one or more of storages 2122 and 2138. Each of storages 2122 and 2138 may be utilized to store commands, for example, such that when each of processing circuitries 2118 and 2136, respectively, are prompted through control circuitries 2108 and 2134, respectively. Either of processing circuitries 2118 or 2136 may execute any of the systems, methods, processes, and outputs of one or more of FIGS. 1-20, or any combination of steps thereof.

In some embodiments, control circuitry 2108 and/or 2134 executes instructions for an application stored in memory (e.g., storage 2122 and/or storage 2138). Specifically, control circuitry 2108 and/or 2134 may be instructed by the application to perform the functions discussed herein. In some embodiments, any action performed by control circuitry 2108 and/or 2134 may be based on instructions received from the application. For example, the application may be implemented as software or a set of and/or one or more executable instructions that may be stored in storage 2122 and/or 2138 and executed by control circuitry 2108 and/or 2134. The application may be a client/server application where only a client application resides on computing device 2102, and a server application resides on server 2104.

The application may be implemented using any suitable architecture. For example, it may be a stand-alone application wholly implemented on computing device 2102. In such an approach, instructions for the application are stored locally (e.g., in storage 2122), and data for use by the application is downloaded on a periodic basis (e.g., from an out-of-band feed, from an internet resource or using another suitable approach). Control circuitry 2108 may retrieve instructions for the application from storage 2122 and process the instructions to perform the functionality described herein. Based on the processed instructions, control circuitry 2108 may determine a type of action to perform based at least in part on input received from I/O circuitry 2112 or from communication network 2106.

The computing device 2102 is configured to communicate with an I/O device (not shown) via the I/O circuitry 2112. In some embodiments, the user input 2114 is received from the I/O device. A wired and/or wireless connection between the I/O circuitry 2112 and the I/O device is provided in some embodiments. The I/O device may be, for example, at least one of a keyboard, a mouse, a touchscreen, a microphone, a scanner, a joystick, a graphics tablet, a monitor, a printer, speakers, headphones, a projector, a headset, a wearable device, a gaming controller, an external hard drive, a USB hard drive, an SD card, a network interface card (NIC), combinations of the same, or the like.

In client/server-based embodiments, control circuitry 2108 may include communication circuitry suitable for communicating with an application server (e.g., server 2104) or other networks or servers. The instructions for conducting the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 2106). In another example of a client/server-based application, control circuitry 2108 runs a web browser that interprets web pages provided by a remote server (e.g., server 2104). For example, the remote server may store the instructions for the application in a storage device.

The remote server may process the stored instructions using circuitry (e.g., control circuitry 2134) and/or generate displays. Computing device 2102 may receive the displays generated by the remote server and may display the content of the displays locally via display 2110. For example, display 2110 may be utilized to present a string of characters. This way, the processing of the instructions is performed remotely (e.g., by server 2104) while the resulting displays, such as the display windows described elsewhere herein, are provided locally on computing device 2104. Computing device 2102 may receive inputs from the user via input/output circuitry 2112 and transmit those inputs to the remote server for processing and generating the corresponding displays.

Alternatively, computing device 2102 may receive inputs from the user via input/output circuitry 2112 and process and display the received inputs locally, by control circuitry 2108 and display 2110, respectively. For example, input/output circuitry 2112 may correspond to a keyboard and/or a set of and/or one or more speakers/microphones which are used to receive user inputs (e.g., input as displayed in a search bar or a display of FIG. 21 on a computing device). Input/output circuitry 2112 may also correspond to a communication link between display 2110 and control circuitry 2108 such that display 2110 updates based at least in part on inputs received via input/output circuitry 2112 (e.g., simultaneously update what is shown in display 2110 based on inputs received by generating corresponding outputs based on instructions stored in memory via a non-transitory, computer-readable medium).

Server 2104 and computing device 2102 may transmit and receive content and data such as media content via communication network 2106. For example, server 2104 may be a media content provider, and computing device 2102 may be a smart television configured to download or stream media content, such as a live news broadcast, from server 2104. Control circuitry 2134, 2108 may send and receive commands, requests, and other suitable data through communication network 2106 using communication circuitry 2132, 2126, respectively. Alternatively, control circuitry 2134, 2108 may communicate directly with each other using communication circuitry 2132, 2126, respectively, avoiding communication network 2106.

It is understood that computing device 2102 is not limited to the embodiments and methods shown and described herein. In nonlimiting examples, computing device 2102 may be a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other device, computing equipment, or wireless device, and/or combination of the same, capable of suitably displaying and manipulating media content.

Computing device 2102 receives user input 2114 at input/output circuitry 2112. For example, computing device 2102 may receive a user input such as a user swipe or user touch. It is understood that computing device 2102 is not limited to the embodiments and methods shown and described herein.

User input 2114 may be received from a user selection-capturing interface that is separate from device 2102, such as a remote-control device, trackpad, or any other suitable user movement-sensitive, audio-sensitive or capture devices, or as part of device 2102, such as a touchscreen of display 2110. Transmission of user input 2114 to computing device 2102 may be accomplished using a wired connection, such as an audio cable, USB cable, ethernet cable and the like attached to a corresponding input port at a local device, or may be accomplished using a wireless connection, such as Bluetooth, Wi-Fi, WiMAX, GSM, UTMS, CDMA, TDMA, 8G, 4G, 4G LTE, 5G, NearLink, ultra-wideband technology, or any other suitable wireless transmission protocol. Input/output circuitry 2112 may include a physical input port such as a 12.5 mm (0.4921 inch) audio jack, RCA audio jack, USB port, ethernet port, or any other suitable connection for receiving audio over a wired connection or may include a wireless receiver configured to receive data via Bluetooth, Wi-Fi, WiMAX, GSM, UTMS, CDMA, TDMA, 3G, 4G, 4G LTE, 5G, NearLink, ultra-wideband technology, or other wireless transmission protocols.

Processing circuitry 2118 may receive user input 2114 from input/output circuitry 2112 using communication path 2116. Processing circuitry 2118 may convert or translate the received user input 2114 that may be in the form of audio data, visual data, gestures, or movement to digital signals. In some embodiments, input/output circuitry 2112 performs the translation to digital signals. In some embodiments, processing circuitry 2118 (or processing circuitry 2136, as the case may be) conducts disclosed processes and methods.

Processing circuitry 2118 may provide requests to storage 2122 by communication path 2120. Storage 2122 may provide requested information to processing circuitry 2118 by communication path 2146. Storage 2122 may transfer a request for information to communication circuitry 2126 which may translate or encode the request for information to a format receivable by communication network 2106 before transferring the request for information by communication path 2128. Communication network 2106 may forward the translated or encoded request for information to communication circuitry 2132, by communication path 2130.

At communication circuitry 2132, the translated or encoded request for information, received through communication path 2130, is translated or decoded for processing circuitry 2136, which will provide a response to the request for information based on information available through control circuitry 2134 or storage 2138, or a combination thereof. The response to the request for information is then provided back to communication network 2106 by communication path 2140 in an encoded or translated format such that communication network 2106 forwards the encoded or translated response back to communication circuitry 2126 by communication path 2142.

At communication circuitry 2126, the encoded or translated response to the request for information may be provided directly back to processing circuitry 2118 by communication path 2154 or may be provided to storage 2122 through communication path 2144, which then provides the information to processing circuitry 2118 by communication path 2146. Processing circuitry 2118 may also provide a request for information directly to communication circuitry 2126 through communication path 2152, where storage 2122 responds to an information request (provided through communication path 2120 or 2144) by communication path 2124 or 2146 that storage 2122 does not contain information pertaining to the request from processing circuitry 2118.

Processing circuitry 2118 may process the response to the request received through communication paths 2146 or 2154 and may provide instructions to display 2110 for a notification to be provided to the users through communication path 2148. Display 2110 may incorporate a timer for providing the notification or may rely on inputs through input/output circuitry 2112 from the user, which are forwarded through processing circuitry 2118 through communication path 2148, to determine how long or in what format to provide the notification. When display 2110 determines the display has been completed, a notification may be provided to processing circuitry 2118 through communication path 2150.

The communication paths provided in FIG. 21 between computing device 2102, server 2104, communication network 2106, and all subcomponents depicted are examples and may be modified to reduce processing time or enhance processing capabilities for each step in the processes disclosed herein by one skilled in the art.

### Terminology

The terminology used herein is for the purpose of describing particular embodiments only and is not intended to be limiting of the disclosure.

It is to be understood that various terms relating to latency may be understood as set forth in the following. These latency terms are not intended to be limiting but exemplary. “High” latency is, e.g., about 45 seconds or more. An example of this is DASH and/or HLS with 10-second segments. “Typical” latency ranges, e.g., from about 10 to about 45 seconds. This can be seen in DASH and/or HLS with 6-second segments. DASH and/or HLS with 2-second segments falls between low latency and typical latency. “Low” latency is, e.g., between about 1 and 10 seconds. Examples include DASH and/or HLS with fragmented or 1-second segments, cable, IPTV, satellite, over-the-air broadcast, social media, messaging, live sports, game streaming, and eSports. Online gambling, betting, and auctioning fall between ultra-low latency and low latency. “Ultra-low” latency is, e.g., about 100 milliseconds to about 1 second. Cloud gaming, videoconferencing, and Voice over IP (VOIP) straddle the line between near-real-time latency and ultra-low latency. “Near-real-time” latency is, e.g., less than about 100 milliseconds. An example of this is surgical robots. Other examples include different game genres. For example, for a role playing fantasy game, a latency of less than about 100 milliseconds is likely sufficient. Whereas, in a first-person shooter game, end-to-end latency below about 40 milliseconds is desirable. In another example, VR cloud gaming pushes these latencies even lower to below about 20 milliseconds.

Throughout the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises.”

Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

As used herein, the terms “real time,” “simultaneous,” “substantially on-demand,” and the like are understood to be nearly instantaneous but may include delay due to practical limits of the system. Such delays may be in the order of milliseconds or microseconds, depending on the application and nature of the processing. Relatively longer delays (e.g., greater than a millisecond) may result due to communication or processing delays, particularly in remote and cloud-computing environments.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although at least some embodiments are described as using a plurality of units or modules to perform a process or processes, it is understood that the process or processes may also be performed by one or a plurality of units or modules. Additionally, it is understood that the term controller/control unit may refer to a hardware device that includes a memory and a processor. The memory may be configured to store the units or the modules, and the processor may be specifically configured to execute said units or modules to perform one or more processes which are described herein.

Unless specifically stated or obvious from context, as used herein, the term “about” is understood as within a range of normal tolerance in the art, for example, within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The use of the terms “first”, “second”, “third”, and so on, herein, are provided to identify structures or operations, without describing an order of structures or operations, and, to the extent the structures or operations are used in an embodiment, the structures may be provided or the operations may be executed in a different order from the stated order unless a specific order is definitely specified in the context.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory (e.g., a non-transitory, computer-readable medium accessible by an application via control or processing circuitry from storage) including, but not limited to, volatile and non-volatile computer memory or storage devices such as a hard disk, floppy disk, USB drive, DVD, CD, media cards, register memory, processor caches, random-access memory (RAM), UltraRAM, cloud-based storage, and the like.

The interfaces, processes, and analysis described may, in some embodiments, be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

Any use of a phrase such as “in some embodiments” or the like with reference to a feature is not intended to link the feature to another feature described using the same or a similar phrase. Any and all embodiments disclosed herein are combinable or separately practiced as appropriate. Absence of the phrase “in some embodiments” does not infer that the feature is necessary. Inclusion of the phrase “in some embodiments” does not infer that the feature is not applicable to other embodiments or even all embodiments.

The systems and processes discussed herein are intended to be illustrative and not limiting. One skilled in the art would appreciate that the actions of the processes discussed herein may be omitted, modified, combined, duplicated, rearranged, and/or substituted, and any additional actions may be performed without departing from the scope of the invention. More generally, the disclosure herein is meant to provide examples and is not limiting. Only the claims that follow are meant to set bounds as to what the present disclosure includes. Furthermore, it should be noted that the features and limitations described in any some embodiments may be applied to any other embodiment herein, and flowcharts or examples relating to some embodiments may be combined with any other embodiment in a suitable manner, done in different orders, or done in parallel. In addition, the methods and systems described herein may be performed in real time. It should also be noted that the methods and/or systems described herein may be applied to, or used in accordance with, other methods and/or systems.

This description is to be taken only by way of example and not to otherwise limit the scope of the embodiments herein. Therefore, it is the object of the appended claims to cover all such variations and modifications as come within the true spirit and scope of the embodiments herein.

1. A method comprising:
implementing an encoding process for encoding, via one or more encoders, a sequence of encoded frames from a sequence of uncompressed frames;
generating a frame-level predicted frame for an uncompressed frame in the sequence of uncompressed frames, wherein the uncompressed frame is upcoming in the sequence of uncompressed frames and the uncompressed frame does not yet have a corresponding encoded frame, based at least in part on a previously encoded frame that was encoded based at least in part on a previous uncompressed frame;
generating a block-based predicted (BBP) frame for the uncompressed frame by generating predicted content in each of a plurality of blocks for the BPP frame based at least in part on a comparison of information from a plurality of previously encoded frames including the previously encoded frame;
estimating a residual complexity associated with the uncompressed frame by comparing (i) the frame-level predicted frame for the uncompressed frame and (ii) the BBP frame for the uncompressed frame;
configuring the one or more encoders based at least in part on the estimated residual complexity before the uncompressed frame is available from the sequence of uncompressed frames for the encoding process; and
generating an encoded frame for the uncompressed frame using the configured one or more encoders.

2. The method of claim 1, wherein the comparison of the information from the plurality of previously encoded frames including the previously encoded frame comprises comparison of (i) motion information determined by analyzing movement of one or more of the plurality of blocks across one or more decoded frames for previously encoded frames, and (ii) a comparison between (a) a previous one or more uncompressed frames in the sequence of uncompressed frames for which encoded frames have been generated and (b) a previous BBP frame generated during the encoding process for each of the previous one or more uncompressed frames.

3. The method of claim 2, wherein the (ii) comparison between (a) the previous one or more uncompressed frames and (b) the previous BBP frame comprises calculating a difference metric indicative of the residual complexity.

4. The method of claim 1, wherein the configuring the one or more encoders comprises adjusting a quantization parameter (QP) based at least in part on the estimated residual complexity.

5. The method of claim 1, wherein the configuring the one or more encoders comprises determining a number of encoders required based at least in part on the estimated residual complexity.

6. The method of claim 5, comprising dynamically adjusting the number of encoders.

7. The method of claim 1, wherein the generating the BBP frame is performed using a trained model.

8. The method of claim 1, wherein the generating the BBP frame is performed using a trained neural network.

9. The method of claim 1, wherein the generating the BBP frame comprises spatial prediction.

10. The method of claim 1, wherein the generating the BBP frame comprises temporal prediction.

11-60. (canceled)

61. A system comprising circuitry configured to:
implement an encoding process for encoding, via one or more encoders, a sequence of encoded frames from a sequence of uncompressed frames;
generate a frame-level predicted frame for an uncompressed frame in the sequence of uncompressed frames, wherein the uncompressed frame is upcoming in the sequence of uncompressed frames and the uncompressed frame does not yet have a corresponding encoded frame, based at least in part on a previously encoded frame that was encoded based at least in part on a previous uncompressed frame;
generate a block-based predicted (BBP) frame for the uncompressed frame by generating predicted content in each of a plurality of blocks for the BPP frame based at least in part on a comparison of information from a plurality of previously encoded frames including the previously encoded frame;
estimate a residual complexity associated with the uncompressed frame by comparing (i) the frame-level predicted frame for the uncompressed frame and (ii) the BBP frame for the uncompressed frame;
configure the one or more encoders based at least in part on the estimated residual complexity before the uncompressed frame is available from the sequence of uncompressed frames for the encoding process; and
generate an encoded frame for the uncompressed frame using the configured one or more encoders.

62. The system of claim 61, wherein the comparison of the information from the plurality of previously encoded frames including the previously encoded frame comprises comparison of (i) motion information determined by analyzing movement of one or more of the plurality of blocks across one or more decoded frames for previously encoded frames, and (ii) a comparison between (a) a previous one or more uncompressed frames in the sequence of uncompressed frames for which encoded frames have been generated and (b) a previous BBP frame generated during the encoding process for each of the previous one or more uncompressed frames.

63. The system of claim 62, wherein the (ii) comparison between (a) the previous one or more uncompressed frames and (b) the previous BBP frame comprises calculating a difference metric indicative of the residual complexity.

64. The system of claim 61, wherein the circuitry configured to configure the one or more encoders is further configured to adjust a quantization parameter (QP) based at least in part on the estimated residual complexity.

65. The system of claim 61, wherein the circuitry configured to configure the one or more encoders is further configured to determine a number of encoders required based at least in part on the estimated residual complexity.

66. The system of claim 65, wherein the circuitry is further configured to dynamically adjust the number of encoders.

67. The system of claim 61, wherein the circuitry configured to generate the BBP frame utilizes a trained model.

68. The system of claim 61, wherein the circuitry configured to generate the BBP frame utilizes a trained neural network.

69. The system of claim 61, wherein the circuitry configured to generate the BBP frame comprises spatial prediction.

70. The system of claim 61, wherein the circuitry configured to generate the BBP frame comprises temporal prediction.

71-301. (canceled)
